(19) United States
(12) Patent Application Publication
(10) Pub. No.: US 2012/0054311 A1
(43) Pub. Date: Mar. 1, 2012

(54) IMAGE DELIVERY SYSTEM, IMAGE DISPLAY DEVICE AND IMAGE DELIVERY SERVER

(75) Inventors: Kimiyasu Mizuno, Tokyo (JP); Shigeru Futawatari, Tokyo (JP); Naotaka Uehara, Tokyo (JP); Masaaki Kikuchi, Tokyo (JP); Sumito Shinohara, Tokyo (JP); Takayuki Kogane, Tokyo (JP); Tetsuya Handa, Tokyo (JP); Hirotaka Yuno, Tokyo (JP)

(73) Assignee: CASIO COMPUTER CO., LTD., Tokyo (JP)

(21) Appl. No.: 13/205,758

(22) Filed: Aug. 9, 2011

(30) Foreign Application Priority Data
Aug. 31, 2010 (JP) 2010-193992
Feb. 28, 2011 (JP) 2011-042368

(51) Int. Cl. G06F 15/16

(52) U.S. Cl. 709/218

(57) ABSTRACT

An image display device, an image delivery system and an image delivery server are provided by which images that are to be delivered to another digital photo frame can be easily differentiated. When an operation for replaying images is performed, the image display device starts for each image, a playback timer to measure its viewing duration and stores the viewing duration in the image file. Then, the image display device collectively transfers all the images to an image selection server at a predetermined timing or by a user operation, and the image selection server transmits images whose viewing durations are equal to or more than a predetermined threshold to another image display device as e-mail attachments at a transfer timing. As a result, the other image display device receives different interesting images every day by e-mail.

### CROSS-REFERENCE TO RELATED APPLICATIONS

This application is based upon and claims the benefit of priority from the prior Japanese Patent Applications No. 2010-193992, filed Aug. 31, 2010 and No. 2011-042368, filed Feb. 28, 2011, the entire contents of which are incorporated herein by reference.

### BACKGROUND OF THE INVENTION

1. Field of the Invention

The present invention relates to a technology for delivering and sharing images between distant locations. In particular, the present invention relates to an image delivery system, an image display device and an image delivery server related to image delivery via the Internet.

2. Description of the Related Art

In recent years, it has become common to store photographs as digital image data, as a result of the spread of digital cameras. Unlike images taken by a conventional film camera which usually require printing, image data can be viewed in the digital camera used to capture the image or in a personal computer and the like into which the image data has been loaded. Accordingly, the way to enjoy photographs is also changing. First, these technologies and trends in the culture of photography will be briefly described with reference to patent documents.

In consideration of the above-described circumstances, so-called digital photo frames have been actualized so that image data can be enjoyed in a manner similar to that of conventional printed photographs, which are now in widespread use (for example, refer to Japanese Patent Application Laid-Open (Kokai) Publication No. 2009-141678).

With such digital photo frames, users can replay and view captured images anytime they wish, or display the captured images in a slideshow. In addition, digital photo frames can be used as album terminals for storing image data.

Moreover, a digital photo frame has been proposed that can be connected to a network to transmit and receive mail (for example, refer to Japanese Patent Application Laid-Open (Kokai) Publication No. 2010-061246).

Furthermore, a digital photo frame has also been proposed that enables a plurality of people to view images. In this digital photo frame, information on a plurality of viewers is registered, and the method of displaying images and the like are changed depending on the viewer (for example, refer to Japanese Patent Application Laid-Open (Kokai) Publication No. 2010-086914).

Still further, a technology has been proposed in which image processing is performed on an image to generate and display an image based on the original image which has a style (such as a painting style) differing from that of the original image (for example, refer to Japanese Patent Application Laid-Open (Kokai) Publication No. 08-044867).

Yet still further, a technology developed from the technology in Japanese Patent Application Laid-Open (Kokai) Publication No. 08-044867 has also been proposed in which features, such as color information and brush stroke information, are extracted from an image of a painting actually painted by an artist, and the extracted features are added to a captured image, whereby the captured image is converted to a highly artistic and painting-like image based on the overall original image (for example, refer to Japanese Patent Application Laid-Open (Kokai) Publication No. 2004-213598).

Yet still further, a technology has also been proposed in which changes in an image are made by changing the image quality to a painting style or the like (for example, refer to Japanese Patent (Kokoku) Publication No. 01-046905).

Yet still further, a technology has been proposed in which, when a plurality of images are being sequentially switched and displayed in a manner similar to a slideshow, images not suitable for the display are effectively prevented from being inadvertently displayed (for example, refer to Japanese Patent Application Laid-Open (Kokai) Publication No. 2009-288507).

On another note, the capacities of memory cards have been increased and the prices of memory cards have been decreased. Consequently, a case has been increasing in which a family possesses a plurality of digital cameras, and accumulates captured photographs in a plurality of memory cards, resulting in disorganized data in the memory cards. When photographs stored in a memory card are disorganized, the user is required to replay and check each photograph in the digital camera or the digital photo frame, before organizing them by sorting into folders on a personal computer or the like and storing therein.

In consideration of this background, a technology has been proposed in which, when a large number of images are stored on a personal computer, the images are automatically sorted into folders in accordance with information set in advance, and efficiently organized based on the classification information (for example, refer to Japanese Patent Application Laid-Open (Kokai) Publication No. 2009-087099).

In conventional digital photo frames such as those described above, there is an issue in that they merely display images recorded therein or the memory card and therefore are not attractive enough.

Accordingly, a technology has been proposed in which a digital photo frame is connected to the Internet, and various content images are delivered for free or a fee (for example, refer to Japanese Patent Application Laid-Open (Kokai) Publication No. 2003-091675).

According to the technology described in Japanese Patent Application Laid-Open (Kokai) Publication No. 2003-091675, a digital photo frame can receive the delivery of free or paid contents of a plurality of categories such as news and advertisements.

However, this technique has a problem in that the popularity degree according to delivered information distinction and individual distinction, such as who has viewed the delivered information and whether the delivered information has been viewed repeatedly or only once, is not known.

To explain the usage of the above-described digital photo frame, a case is described in which a grandchild and the parents (grandchild's household) and the grandparents (grandparents' household) live at a distance from each other, and the grandparents' household has a digital photo frame with a mail receiving function such as that in Japanese Patent Application Laid-Open (Kokai) Publication No. 2010-061246. First, the grandchild's household takes photographs with a digital camera, and uploads the large number of accumulated photographs (assumed to be mainly photographs of the grandchild) in their entirety to a photograph server without sorting them. Then, the photograph server delivers the plurality of photographs to the digital photo frame of the grandparents' household, as an e-mail attachment.

Here, a problem arises. When all the photographs are delivered, uninteresting photographs are also delivered to the grandparents' household.

To avoid the problem, the grandchild's household may sort the photographs such as by selecting photographs showing the grandchild, and upload the selected photographs to the photograph server. However, the sorting operation is time-consuming, and therefore requires a sorting operation which creates a problem in that it causes the grandchild and the parents, who are busy with daily life, to stop using the system.

### SUMMARY OF THE INVENTION

The present invention has been conceived in light of the above-described problems. An object of the present invention is to provide an image delivery system, an image display device, and an image delivery server by which images that are to be delivered to another digital photo frame are easily differentiated.

In order to achieve the above-described object, in accordance with one aspect of the present invention, there is provided an image delivery system including an image display device, and a server that receives an image from the image display device via a network and delivers the received image to another image display device for displaying the delivered image via the network, comprising: an additional information generation section which generates additional information related to a result of an operation or processing performed on the image; a storage control section which stores the additional information generated by the additional information generation section in association with the image; an image selection section which selects an image to be transferred to the other image display device based on the additional information stored in association with the image by the storage control section; and a delivery section which delivers the image selected by the image selection section to the other image display device.

The present invention has an advantageous effect in that images that are to be delivered to a predetermined delivery destination, such as a digital photo frame of a grandparents' household, are easily differentiated.

### BRIEF DESCRIPTION OF THE DRAWINGS

FIG. 1 is an outer appearance view of an image display device 1 according to a first embodiment to which the present invention has been applied;

FIG. 2 is a block diagram showing the electrical configuration of the image display device 1 according to the first embodiment;

FIG. 3 is a block diagram showing the configuration of a network system to which the image display device 1 according to the first embodiment is applied;

FIG. 4 is a conceptual diagram showing the structure of an image file stored in a memory card 60 of the image display device 1 according to the first embodiment;

FIG. 5 is a conceptual diagram showing the configuration of folders in an internal memory 14 of the image display device 1 according to the first embodiment;

FIG. 6 is a conceptual diagram showing the configuration of an address book 33 configured in the internal memory 14 of the image display device 1 according to the first embodiment;

FIG. 7 is a flowchart of procedures performed to register a user's face and a user's e-mail address in association with each other, in the initial setting of the image display device 1 according to the first embodiment;

FIG. 8 is a flowchart of procedures performed in the image display device 1 according to the first embodiment when the memory card 60, such as an SD card, is inserted into a memory card slot 6 and images in the memory card 60 are stored in the internal memory 14;

FIG. 9 is a flowchart of procedures performed when the image display device 1 according to the first embodiment receives e-mail;

FIG. 10 is a flowchart for explaining a playback operation of the image display device 1 according to the first embodiment;

FIG. 11 is a flowchart of procedures performed for slideshow playback during the playback operation of the image display device 1 according to the first embodiment;

FIG. 12 is a conceptual diagram showing another folder configuration of the image display device 1 according to the first embodiment;

FIG. 13 is a block diagram showing an example of a content delivery service via a network which is related to an image delivery system according to the first embodiment;

FIG. 14 is a conceptual diagram for explaining the analysis of log information that characterizes the first embodiment;

FIG. 15 is a flowchart outlining the operation of log recording performed in the image display device 1 according to the first embodiment;

FIG. 16 is a conceptual diagram showing an example of the file configuration of content delivered from a delivery content site 530 and temporarily stored in a content server 524 of a network service site 520, in the first embodiment;

FIG. 17 is a block diagram showing the configuration of a network system to which an image display device 1 according to a second embodiment is applied;

FIG. 18 is a conceptual diagram showing the structure of an image file stored in the memory card 60 of an image display device 1-1 according to the second embodiment;

FIG. 19 is a flowchart for explaining a playback operation of the image display device 1-1 according to the second embodiment;

FIG. 20 is a flowchart for explaining an operation of an image selection server 525 according to the second embodiment;

FIG. 21 is a conceptual diagram showing the structure of an image file stored in the memory card 60 of an image display device 1-1 according to a third embodiment;

FIG. 22 is a flowchart of procedures performed in the image display device 1-1 according to the third embodiment when the memory card 60, such as an SD card, is inserted into the memory card slot 6 and images stored in the memory card 60 are stored in the internal memory 14;

FIG. 23 is a flowchart for explaining an operation of the image selection server 525 according to the third embodiment;

FIG. 24 is a block diagram showing the configuration of a network system to which an image display device 1-2 according to a fourth embodiment is applied;

FIG. 25 is a conceptual diagram showing the structure of an image file stored in the memory card 60 in an image display device 1-1 according to the fourth embodiment;

FIG. 26 is a flowchart for explaining an editing operation of a personal computer 510 according to the fourth embodiment;

FIG. 27 is a flowchart for explaining an operation of an image selection server 525 according to the fourth embodiment;

FIG. 28 is a block diagram showing the configuration of an image selection server 525 according to a fifth embodiment;

FIG. 29 is a flowchart for explaining an operation of an image display device 1-1 according to the fifth embodiment which is owned by a grandchild's household; and

FIG. 30 is a flowchart for explaining an operation of the image selection server 525 according to the fifth embodiment.

### DETAILED DESCRIPTION OF THE PREFERRED EMBODIMENTS

The preferred embodiments of the present invention will hereinafter be described with reference to the drawings.

### A. First Embodiment

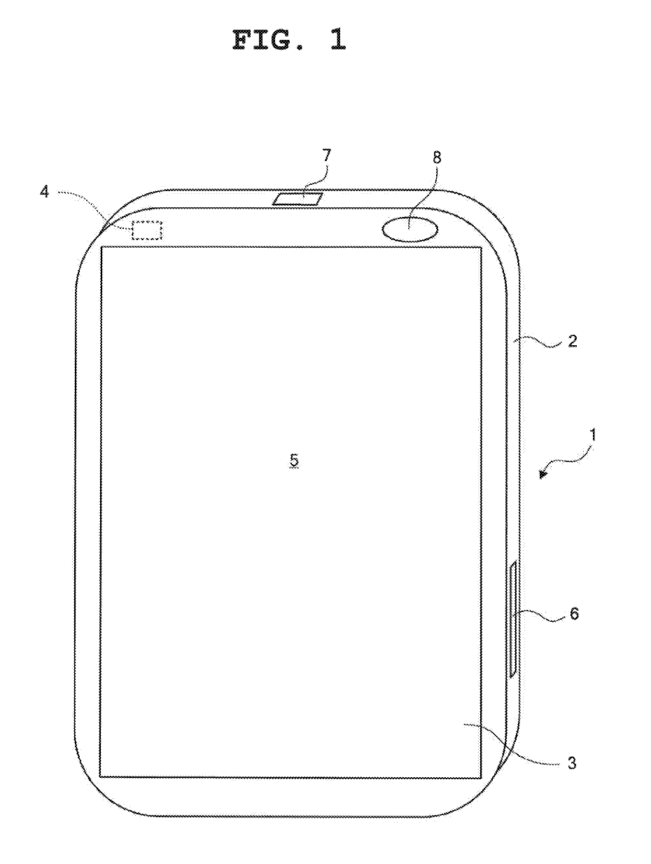

FIG. 1 is an outer appearance view of an image display device 1 according to a first embodiment to which the present invention has been applied. A display section constituted by a liquid crystal display panel 3 held in a main body 2 is provided on the front surface of the image display device 1, and a touch panel 5 is integrally formed on the liquid crystal display panel 3 so that operations can be performed by it being touched with a finger. An image sensor 8 is provided on the right upper portion of the front surface of the main body 2, and a memory card slot 6 is provided on the side surface of the main body 2. A global positioning system (GPS) antenna 7 is provided in the upper portion of the main body 2, and a motion sensor 4 is provided on the left upper portion of the front surface of the main body 2.

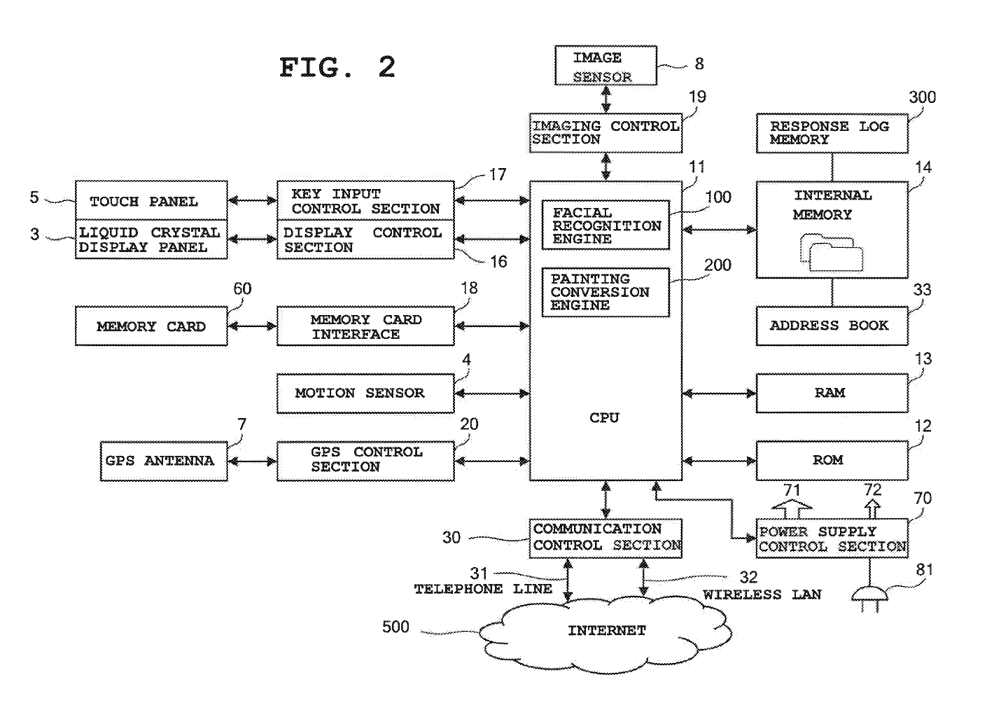

FIG. 2 is a block diagram showing the electrical configuration of the image display device 1 according to the first embodiment. The image display device 1 includes a central processing unit (CPU) 11 (additional information generation section, storage control section, and transfer section), and a read-only memory (ROM) 12, a random access memory (RAM) 13, and an internal memory 14 that are connected to the CPU 11. The ROM 12 stores programs used by the CPU 11 to perform operations shown in flowcharts described hereafter, and the CPU 11 includes a facial recognition engine 100 for performing recognition processing on a face captured by the image sensor 8, and a painting conversion engine 200 for converting a photographic image to a painting-style image.

The facial recognition engine 100 has the capability to recognize each face when a plurality of faces is shown in a photograph.

The painting conversion engine 200 performs painting conversion processing, such as those disclosed in Japanese Patent Application Laid-Open (Kokai) Publication No. 08-044867 and Japanese Patent Application Laid-Open (Kokai) Publication No. 2004-213598. In the painting conversion processing performed by the painting conversion engine 200, an image to be displayed which has been stored in a memory card 60 is converted to a painting-style image including features of a painting, or in other words, a painting-style image to which certain effects have been added, and the painting-style image after the conversion is displayed in the liquid crystal display panel 3.

Note that the type of painting when an image is converted to a painting-style image can be selected. That is, the features (painting style) of a painting-style image after the conversion can be selected. In the first embodiment, the selectable painting styles are oil painting, water color painting, pastel painting, color pencil sketch, pointillism, and air brush, but are not limited thereto. For example, a configuration may be adopted in which conversion to add features of an artist such as Van Gogh, Monet, or Picasso is selectable. In addition, the algorithms of other painting styles may be provided through the memory card 60 described hereafter.

In the first embodiment, a program for converting an image to six painting styles ranging from oil painting to air brush is stored, and the priority order of the styles is (1) oil painting, (2) water color painting, (3) pastel painting, (4) colored pencil sketch, (5) pointillism, and (6) airbrush, unless otherwise specified by the user.

The RAM 13 is a working memory that temporarily stores various data required by the CPU 11. The internal memory 14 is a large-capacity non-volatile memory such as a hard disk or a flash memory, in which folders can be created and a number of images can be stored as will hereinafter be described in detail. An address book 33 and a response log memory 300 are also included in the internal memory 14.

A display control section 16 displays images and various menus on the liquid crystal display panel 3 by driving the liquid crystal display panel 3 based on image data for display which is provided by the CPU 11. A key input section control section 17 inputs operation signals of the touch panel 5 based on control by the CPU 11.

The touch panel 5 can be selected accordingly from among various existing types of touch panels that use a capacitance method, an optical method, a resistive film method, a surface acoustic wave method, an ultrasonic method, or an electromagnetic induction method, etc. In addition, the touch panel 5 can be configured to have a fingerprint authentication function and a vein pattern authentication function.

A memory card interface 18 is an input and output interface that controls the input and output of data between various memory cards 60 detachably mounted in the memory card slot 6 and the CPU 11.

An imaging control section 19 drives the image sensor 8 to perform control for loading an image of a subject. The image data loaded in Bayer format is converted to YUV and RGB data, compressed in Joint Photographic Experts Group (JPEG) format, and recorded in the internal memory 14 or the memory card 60.

A GPS control section 20 acquires position information based on information received by the GPS antenna 7, whereby the current position of the image display device 1 is detected.

A power supply control section 70 supplies power from a main power supply 71 or a standby power supply 72 to each section by receiving alternating current (AC) power supply via a power supply plug 81 and converting the AC power supply to direct current.

The motion sensor 4, which is constituted by a pyroelectric sensor, a line sensor, or the like, is connected to the CPU 11 and detects whether or not a person is present nearby. Accordingly, when a state in which a person is not present nearby continues for a predetermined amount of time or longer, the CPU 11 controls the power supply control section 70 to automatically turn OFF the main power supply 71 and supply power to only the standby power supply 71 for saving power (auto power OFF). Then, when the motion sensor 4 detects that a person is nearby, the CPU 11 turns ON the main power supply 71.

Also, the motion sensor 4 can measure the angle from which a viewer views the image display device 1 and the distance between the image display device 1 and the viewer. Note that a configuration may be adopted where the image sensor 8 serves as a substitute for the motion sensor 4 and performs the function thereof. The image sensor 8, the imaging control section 19, and the facial recognition engine 100 operate cooperatively, whereby the face of a viewer can be recognized, the power supply can be controlled based on who the viewer is, the angle from which the viewer is viewing the image display device 1 can be detected, and whether the viewer is viewing at close range or from a distance can be detected, as will hereinafter be described in detail.

A communication control section 30 is connected to the Internet 500 via a telephone line 31 or a wireless local area network (LAN) 32, and controls communication including the transmission and reception of e-mail or contents. The address book 33 is practically provided in the internal memory 14 and used for the transmission and reception of e-mail.

The response log memory 300 is provided in the internal memory 14 and stores a viewer response log(history) constituted by results of capturing by the image sensor 8 and recognition by the facial recognition engine 100, response results of the motion sensor 4, touch results of the touch panel 5, etc.

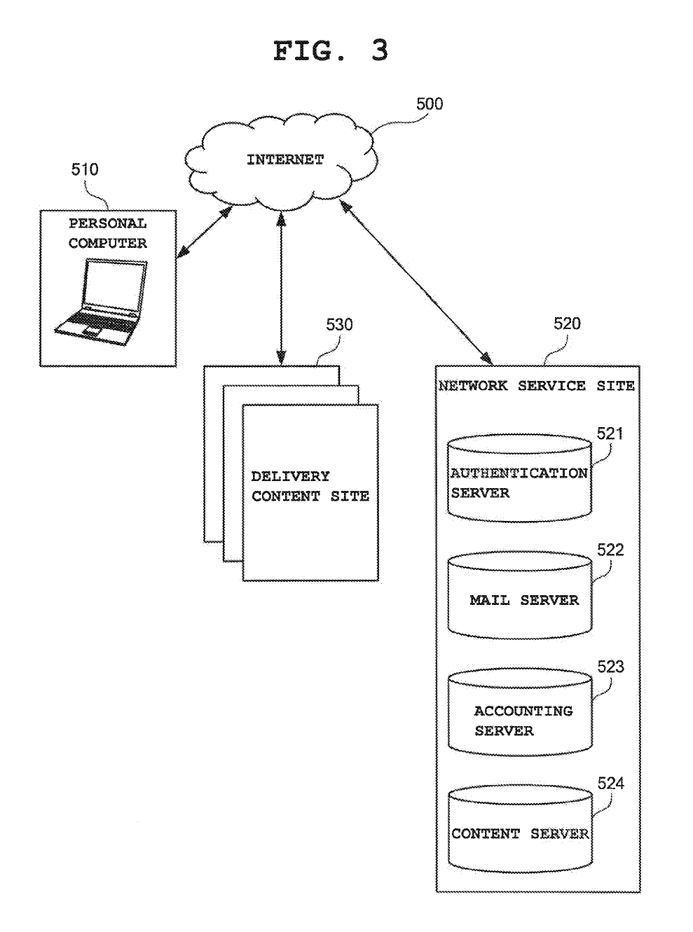

Next, FIG. 3 is a block diagram showing the configuration of a network system to which the image display device 1 according to the first embodiment is applied. Reference numeral 510 indicates a personal computer that can be connected to the image display device 1 via the communication control section 30 by the wireless LAN 32 or the like. Through this personal computer 510, complicated settings which cannot be made by the image display device 1 can be made.

Reference numeral 520 indicates a network service site connected via the Internet 500, which includes at least an authentication server 521, a main server 522, an accounting server 523, and a content server 524, and also serves as a network provider for the image display device 1.

Reference numeral 530 indicates a delivery content site for delivering various contents to be displayed on the image display device 1. The delivery content site 530 has numerous contents, images, etc., and can deliver data to the image display device 1 or the network service site 520 via the Internet 500.

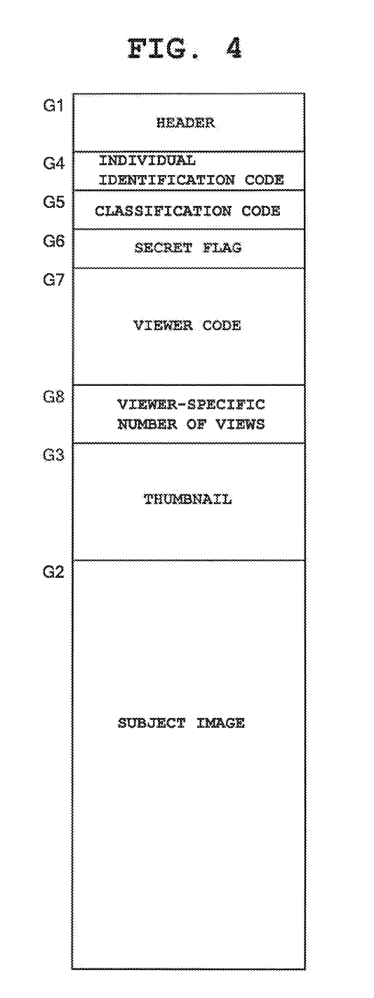

FIG. 4 is a conceptual diagram showing the structure of an image file stored in the memory card 60 of the image display device 1 according to the first embodiment. Each image file includes a header G1 having data in Exchangeable Image File Format (EXIF) or the like, image data G2 of an original captured image, and image data of a thumbnail G3 that is a reduced image of the image data G2. Note that the size of a reduced image to be displayed on a screen differs according to the display screen, and therefore a display preview image other than the thumbnail is created and stored in some cases. In the first embodiment, the expression “thumbnail” includes its preview image. That is, the image file conforms to the file format of a typical digital camera and can be used merely by a secure digital (SD) card (memory card 60) in which images captured by a digital camera have been stored being inserted into the memory card slot 6. As the format of the image file, various formats such as JPEG, Graphics Interchange Format (GIF), Audio Video Interleave (AVI), and Portable Network Graphics (PNG) are applicable.

The following is data unique to the first embodiment. First, G4 is an individual identification code indicating a person who has performed an image storing operation. The identification of the person is performed by facial recognition. This identification code is assigned to each individual, such as “1001” for a father and “1002” for a mother. G5 is a classification code for classifying the intended use of the image into work purpose, personal use, or the like. For example, classification code “01” is recorded for work purpose, “02” is recorded for personal use, and “03” is recorded for travel purpose. The user can freely decide the classifications of images the person has taken. G6 is a secret flag indicating whether or not the image is set as a secret image. The secret flag is “1” when the image is set as a secret image and “0” when the image is not set as a secret image.

G7 is a viewer code indicating a person viewing the image when it is displayed. The identification of the viewer is performed by facial recognition being performed on a person captured by the image sensor 8 while the image is being displayed. When the viewer is a person who has already been registered, the identification code of the person is recorded as a viewer code. When the viewer is a new person who has not been registered, a new viewer code is issued and recorded. G8 stores the number of views for each viewer. Although G7 and G8 are shown separately for convenience, the viewer code and the number of views are stored as a set. That is, in a case where person A has viewed the image twice and person B has viewed the image three times, the viewer code of person A is “1101”*2, and the viewer code of person B is “1052”*3.

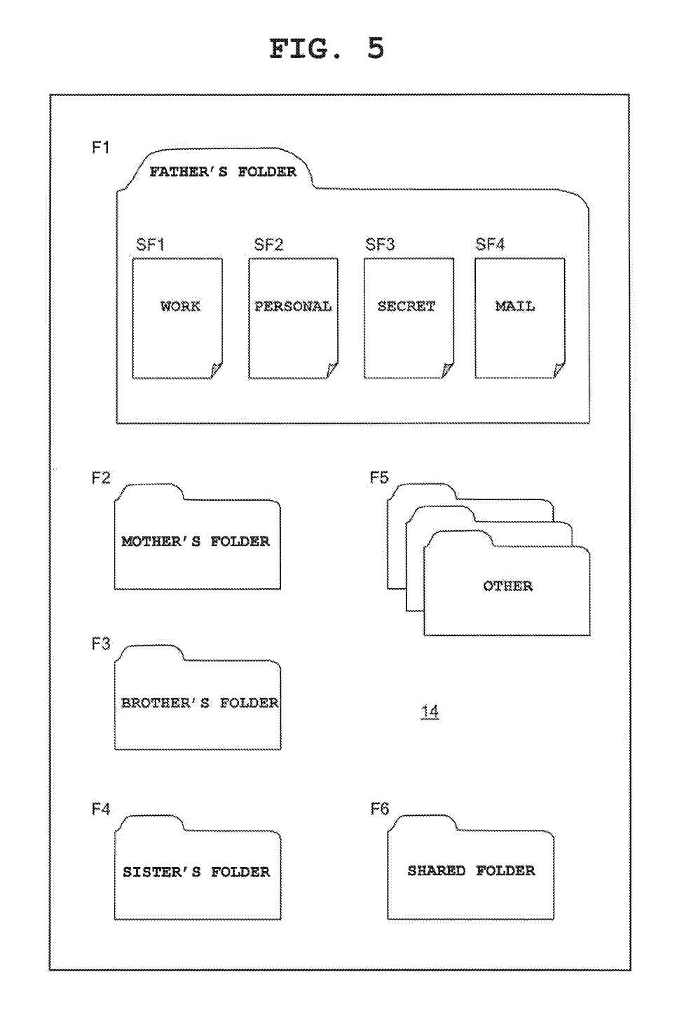

FIG. 5 is a conceptual diagram showing the configuration of folders in the internal memory 14 of the image display device 1 according to the first embodiment. In the first embodiment, a folder is created in the internal memory 14 for each person identified by facial recognition. Although a single image file is shown in FIG. 4, a folder is basically created for each individual identification code G7 of image files. For example, a folder F1 corresponding to the identification code “1001” of the father, a folder F2 corresponding to the identification code “1002” of the mother, and so on are created. In addition, a subfolder SF is created in the individual's folder, based on the classification code G5 of an image file therein, or for images whose secret flags have been set to 1. For example, a work-purpose subfolder SF1, a personal-use subfolder SF2, a subfolder SF3 for images whose secret flag has been set to 1, and a subfolder SF4 for images received by e-mail are created. Note that these folders are logical folders, and the memory area is not physically partitioned.

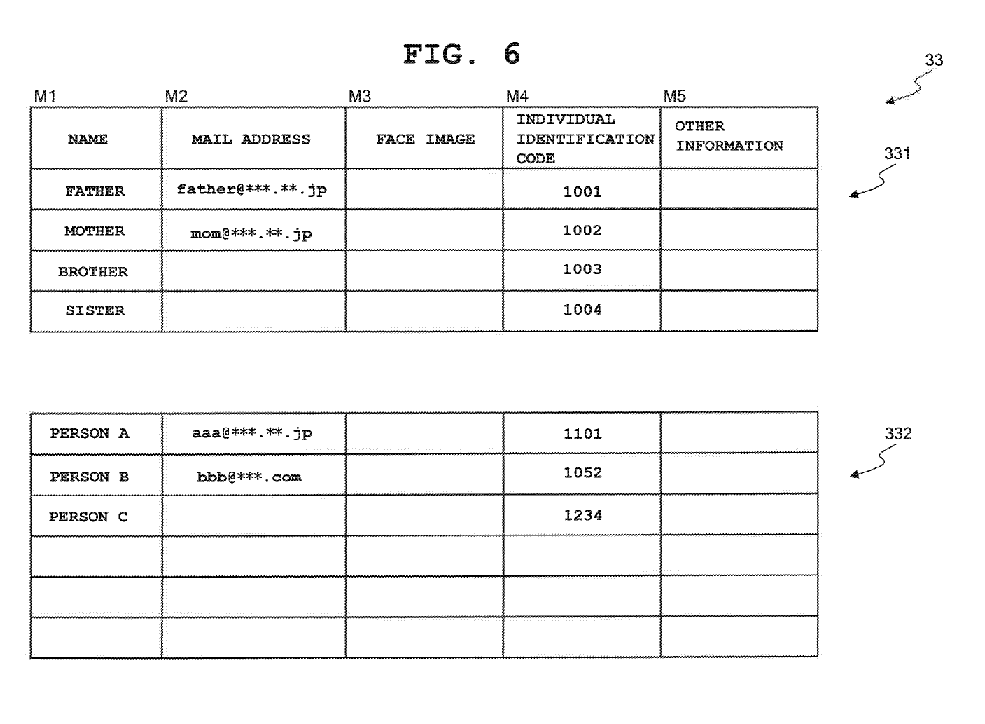

FIG. 6 is a conceptual diagram showing the configuration of the address book 33 configured in the internal memory 14 of the image display device 1 according to the first embodiment. Reference numeral 331 indicates an area for storing the e-mail address information of the owners of the image display device 1 which is referred to as a profile. Reference numeral 332 indicates an area for storing the e-mail address information of destinations with which e-mail is exchanged. Reference numeral M2 is an area in which the e-mail addresses themselves are recorded. Reference numeral M1 is an area in which the names of the e-mail address owners are recorded. These names can be given freely. Reference numeral M3 is an area in which the face images of the e-mail address owners are registered. Reference numeral M4 is an area in which the above-described individual identification codes are recorded. Reference numeral M5 is an area in which other various information are recorded as required, such as street address information and call rejection information.

Hereafter, specific operations of the image display device 1 and the network system according to the first embodiment will be described with reference to flowcharts. To simplify the descriptions, the flowcharts are expressed in accordance with operation procedures performed by the operator, and operations of the circuits and data movement will be described in association therewith.

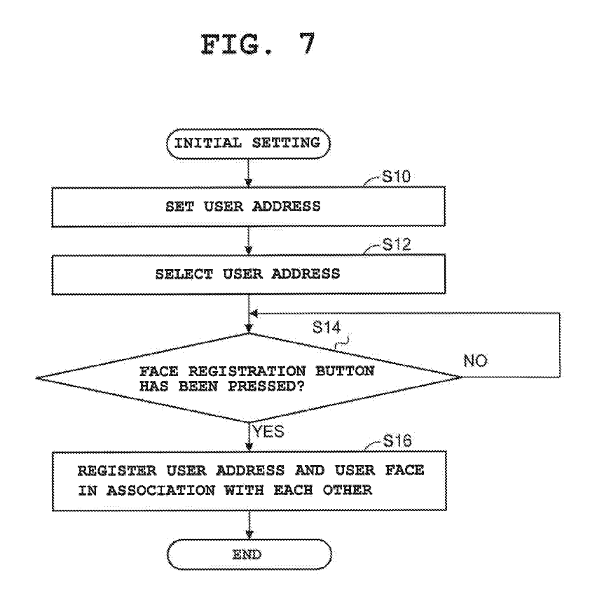

FIG. 7 is a flowchart of procedures performed to register a user's face and a user's e-mail address in association with each other, in the initial setting of the image display device 1 according to the first embodiment. First, a user's e-mail address is set (Step S10). This setting of the user's e-mail address is performed as described below. During initial startup, the image display device 1 and the authentication server 521 are connected via the Internet 500. The mail server 522 issues and provides a unique e-mail address to the image display device 1 after receiving authentication. Next, the user accesses the mail server 522 through the personal computer 510, and changes the unique e-mail address to a desired e-mail address. When the user informs the family and friends of the e-mail address, e-mail including image data can be transmitted and received. This operation is basically similar to initial address settings for personal computers, mobile terminals, etc.

Next, the user (or the users including the owners: it may be multiple users) of the image display device 1 registers his or her own face. The image sensor 8 captures images almost constantly while the power is ON and therefore, when the user touches a face registration button displayed on the liquid crystal display panel 3 via the touch panel 5 (Step S14) while the user's e-mail address is being displayed on the liquid crystal display panel 3 (Step S12), the CPU 11 recognizes the face of the user by the facial recognition engine 100. The CPU 11 then registers the user's e-mail address and the user's face in association with each other, in the address book 33 (Step S16).

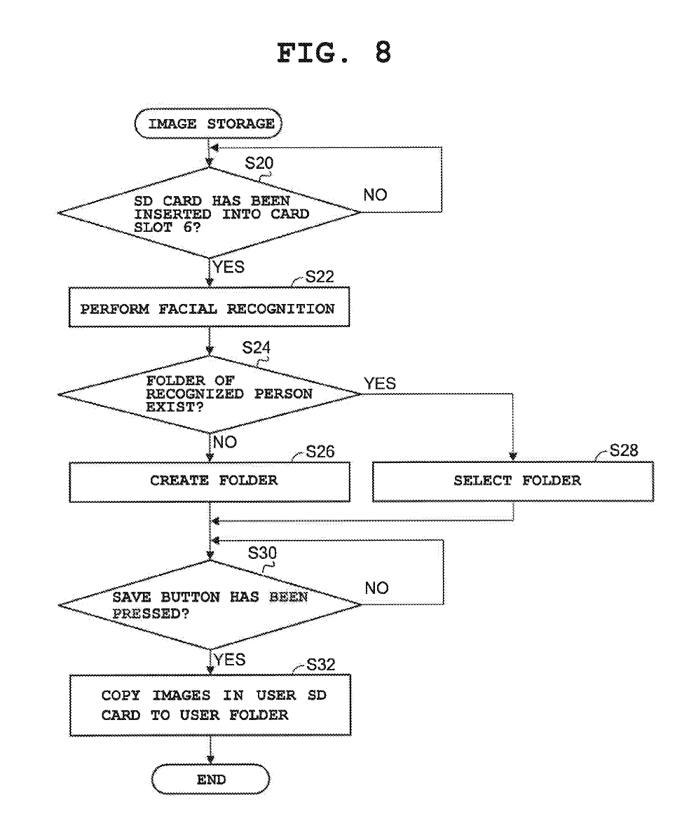

FIG. 8 is a flowchart of procedures performed in the image display device 1 according to the first embodiment when the memory card 60, such as an SD card, is inserted into the memory card slot 6 and images in the memory card 60 are stored in the internal memory 14. First, the CPU 11 judges whether or not the memory card 60 has been inserted into the memory card slot 6 (Step S20). When judged that the memory card 60 has been inserted in the memory card slot 6, the CPU 11 performs facial recognition on the face of the user currently being captured by the image sensor 8, using the facial recognition engine 100 (Step S22).

Next, the CPU 11 judges whether or not an individual identification code has been registered for the face on which facial recognition has been performed (Step S24). That is, since a folder is configured corresponding to an individual identification code as shown in FIG. 5, the CPU 11 judges whether or not the folder of the recognized person exists. When the user is a new user whose folder does not exist, the CPU 11 issues a new identification code, and after registering the user's face, creates a folder (Step S26). Conversely, when the user operating the image display device 1 is, for example, the father having the identification code “1001”, the CPU 11 selects the folder F1 (Step S28). Note that a configuration may be adopted where images cannot be saved by unregistered users.

Next, the CPU 11 judges whether or not a save button displayed on the liquid crystal display panel 3 has been pressed (Step S30). When judged that the save button has been pressed via the touch panel 5, the CPU 11 copies images recorded on the memory card 60 to the corresponding folder (Step S32). That is, the user (operator) can save images in his own folder without being particularly conscious of it. Then, the creation of subfolders based on classifications in the folder and the setting of the secret flag are performed as necessary, according to a menu screen.

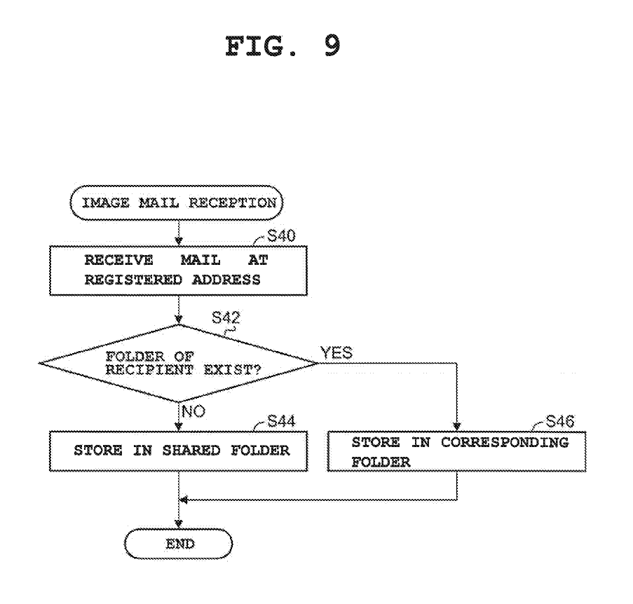

FIG. 9 is a flowchart of procedures performed when the image display device 1 according to the first embodiment receives e-mail. If the user's e-mail address has not been set in the image display device 1, e-mail cannot be received in the first place. However, if it has been set in the image display device 1, and when e-mail is received at, for example, the father's e-mail address (father@***.**.jp) (Step S40), the CPU 11 judges whether or not a folder corresponding to the e-mail address at which the e-mail has been received exists (Step S42). When judged that a corresponding folder does not exist, the CPU 11 stores the received e-mail in the shared folder F6 (Step S44). Conversely, when judged that a folder corresponding to the father's e-mail address, which is the folder F1, exists, the CPU 11 saves the e-mail in the corresponding folder F1 and, if the e-mail has an attached image, saves the image in the image mail subfolder SF4 (Step S46).

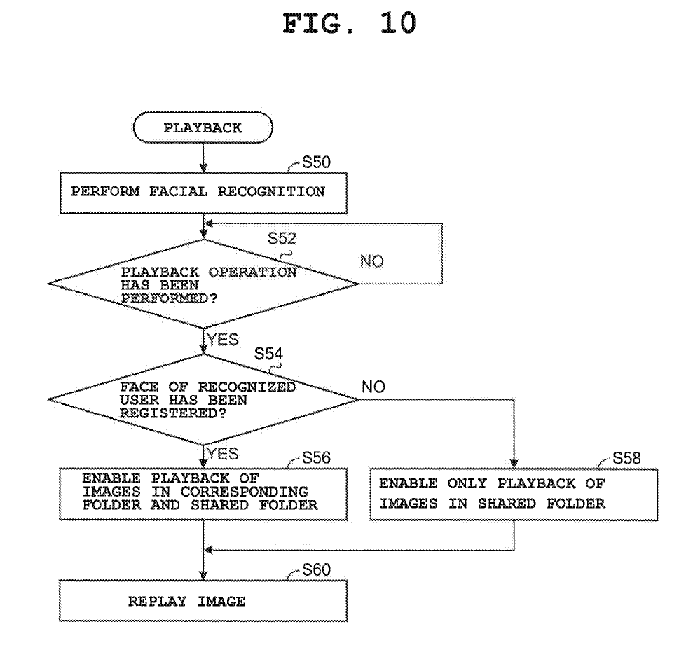

FIG. 10 is a flowchart for explaining a playback operation of the image display device 1 according to the first embodiment. Note that the playback herein refers to the playback of an image stored in the internal memory 14, the playback of an image stored in the inserted memory card 60, the playback of a single image, the playback of images in a slideshow, etc.

When the user (or the operator: both registered and unregistered users are included therein) comes to the front of the image display device 1 to replay an image, since the image sensor 8 is capturing images, the CPU 11 and the facial recognition engine 100 operate cooperatively to recognize the operator's face (Step S50). Next, the CPU 11 judges whether or not a playback operation has been performed (Step S52). When judged that a playback operation has been performed, the CPU 11 judges whether or not the user, whose face has been recognized, has been registered (Step S54). When judged that the face has been registered, since the user can be assumed to be a user of the image display device 1, the CPU 11 enables the playback of images in the corresponding folder. For example, if the user here is the father, images saved in the father's folder F1 and images stored in the shared folder F6 can be replayed (Step S56). Other people's folders such as the mother's folder F2 and the sister's folder F4 cannot be replayed. Conversely, when judged that the face has not been registered, the CPU 11 enables only the playback of the images saved in the shared folder F6 (Step S58). Then, the CPU 11 proceeds to Step S60 and performs a predetermined playback operation.

Here, the facial recognition engine 100 can recognize the faces of a plurality of users shown in an image captured by the image sensor 8, and therefore the contents of the mother's folder F2 can also be replayed if the mother is also shown in the image showing the father.

Control performed when the faces of registered users and unregistered users are simultaneously recognized will be described hereafter.

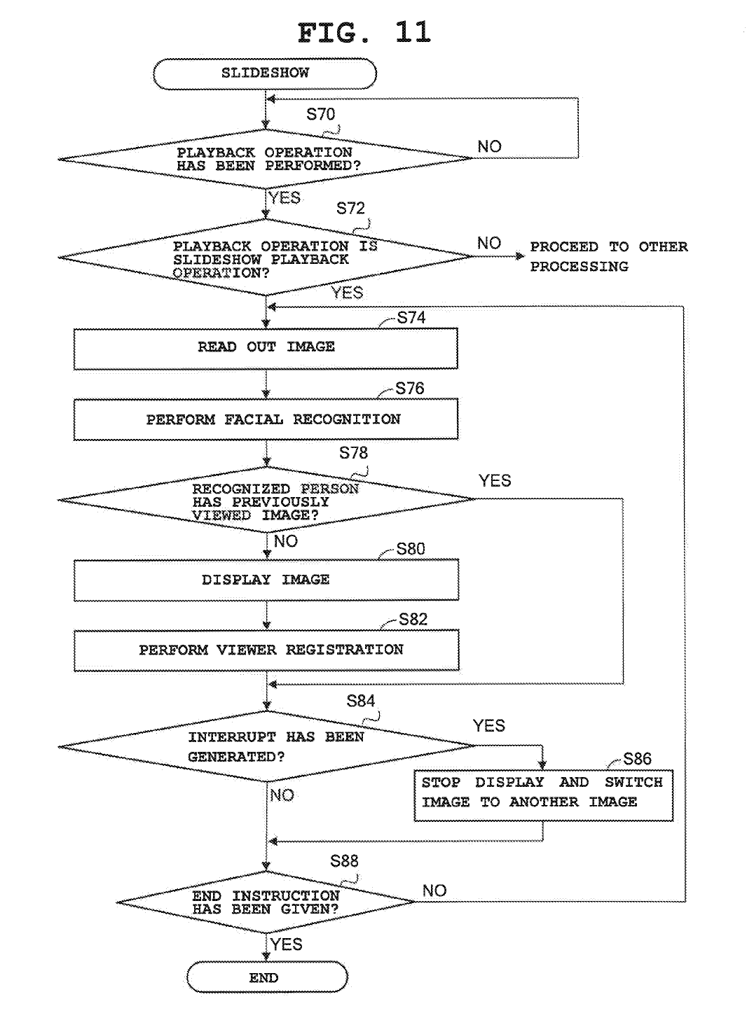

FIG. 11 is a flowchart of procedures performed for slideshow playback during the playback operation of the image display device 1 according to the first embodiment. First, the CPU 11 judges whether or not a playback operation equivalent to that at Step S52 in FIG. 10 has been performed (Step S70). Then, when judged that a playback operation has been performed, the CPU 11 judges whether or not the playback operation is a slideshow playback operation (Step S72). When judged that the playback operation is not a slideshow playback operation, the CPU 11 proceeds to another processing.

Conversely, when judged that the playback operation is a slideshow playback operation, the CPU 11 first reads out a first image (Step S74). Note that the slideshow playback herein refers to the playback of images in a specific folder, playback in chronological order, playback in reverse chronological order, random playback, etc. Next, the CPU 11 performs facial recognition on the viewer (or the viewers including registered and unregistered users) currently viewing the image display device 1 (Step S76). Then, the CPU 11 judges whether or not the recognized face is that of a viewer who has previously viewed the image (Step S78). As shown in FIG. 4, the viewer code G7 is prepared for each image, and once the image is viewed, the viewer code G7 and the number of views G8 therefor are registered as a set.

When judged that the recognized face is not that of a viewer who has previously viewed the image, since the image to be replayed has never been viewed by the viewer whose face has been recognized, the CPU 11 displays the image (Step S80), and after issuing a viewer code, registers his face image, and increments the number of views (Step S82). Conversely, when judged that the recognized face is that of a viewer who has previously viewed the image, since the image to be replayed has been previously viewed by the viewer whose face has been recognized, the CPU 11 skips Step S80 and Step S82, and proceeds to Step S84.

Next, the CPU 11 judges whether or not an interrupt has been generated (Step S84). The interrupt herein refers to processing performed when a viewer currently viewing an image changes or a new viewer joins the viewer during the display of the image. In the first embodiment, facial recognition is performed before an image to be displayed is selected. However, since the same image is displayed continuously for a number of seconds during the slideshow, naturally, the viewer may leave, the number of viewers may increase, or the viewer may change during that time.

Here, processing is described which is performed when an image being displayed is an image that is not desirable to be viewed by a certain person or by people other than the owner. For example, when the face of a person other than the family members of the owner is detected, or in other words, when an interrupt is generated, the CPU 11 stops image display, or reads out another image and switches the image currently being displayed to it (Step S86). In this case, a certain image for switching may be prepared in advance. Note that, although the interrupt processing is described here in this section of the flowchart for convenience, it may be configured to be performed at any time through an interrupt signal.

In addition, when a new viewer joins the owner while an image is being displayed that has been read from the subfolder SF3 for images whose secret flags have been set to 1, the CPU 11 proceeds to Step S86 to stop image display, or read out another image for switching.

Then, the CPU 11 judges whether or not an end instruction has been given (Step S88). When judged that an end instruction has not been given, the CPU 11 returns to Step S74 to read out a next image and repeat the above-described processing. Conversely, when judged an end instruction has been given, the CPU 11 ends the processing.

That is, when a slideshow is displayed over a long time, the same images are repeated, and accordingly the viewer becomes bored. In order to solve this problem, the first embodiment performs facial recognition on the viewer, and displays images that have not been viewed by the viewer.

Although it is not described in detail in the flowchart shown in FIG. 11, when a plurality of viewers are viewing the image display device 1, the images are displayed in order of priority, from images that have not been viewed by anyone, to images that have not been viewed by some, and to images that have been viewed by everyone. That is, images that have not been viewed by anyone are given first priority, images that have not been viewed by some are given second priority, and images that have been viewed by everyone are given third priority.

In this case, first, the images to which the first priority has been given are displayed by slideshow. Next, when the display of all the images to which the first priority has been given is completed, the images to which the second priority has been given are displayed by slideshow. Next, when the display of all the images to which the second priority has been given is completed, the images to which the third priority has been given are displayed by slideshow. Then, when the display of all the images to which the third priority has been given is completed, the images to which the first priority has been given are redisplayed by slideshow.

Note that the above-described processing is, of course, an operation performed in a state in which the number of viewers and the people composing the viewers do not change at a certain moment. Every time the number of viewers or the people composing the viewers changes, the above-described classification of the first, second, and third priorities are changed.

In addition, images whose secret flags G6 have been set to 1 are not considered as display subjects from the start. These images may be displayed only when the viewer is recognized as the owner of the images by facial recognition. In this case, when another person's face is detected at Step S84, the image display is immediately stopped at Step S86.

Also note that images displayed by the procedures in the flowcharts shown in FIG. 10 and FIG. 11 are images on which painting-style conversion has not been performed. With regard to images on which painting-style conversion has been performed, slideshow display can be performed without any limitation. The configuration in this case may be, for example, a configuration in which images in a certain folder are converted to painting-style and displayed, images are converted to painting-style in chronological order or reverse chronological order and displayed, or images are randomly converted to painting-style and displayed, on a condition that these converted painting-style images have been set to slideshow mode.

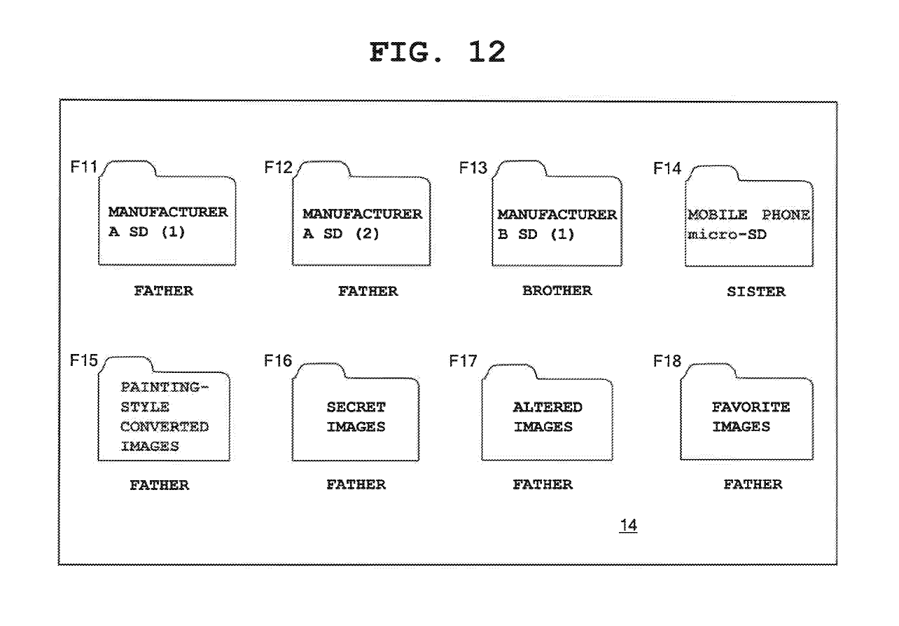

FIG. 12 is a conceptual diagram showing another folder configuration of the image display device 1 according to the first embodiment. In the first embodiment, owner-specific folders based on individual identification codes are created, as shown in FIG. 5. However, a configuration may be adopted in which folders are created and stored in the internal memory 14 for each of a plurality of memory cards 60, as shown in FIG. 12.

Currently, there are many cases in which a number of disorganized SD cards including SD cards for a camera, mini SD cards and micro-SD cards for a mobile phone, and the like are kept, thereby being indistinguishable from each other. In a case as well where a plurality of SD cards are used for a plurality of cameras, a problem occurs where the owner cannot tell in which camera the SD card has been used, when and where images therein have been taken, or what is recorded therein.

Accordingly, in a manner similar to the processing flow shown in FIG. 8, separation into folders is performed by the memory card 60 simply being inserted into the image display device 1, without any special operations being performed. For example, separate folders are created for Manufacturer A SD card (1) F11, Manufacturer A SD card (2) F12, Manufacturer B SD card (1) F13, mobile phone micro-SD card F14, and the like. Manufacturer A and Manufacturer B herein refer to the manufacturer of the camera or the mobile phone. The owner of the folder is made clear by the individual identification code being attached through facial recognition. For example, if the father has inserted the SD card (1), the owner of the folder F11 is the father.

That is, as in the case of the operation described above, when the memory card 60 is inserted into the image display device 1 and images in the memory card 60 are stored, card-specific folders are automatically created without any special operations being performed. Therefore, the image display device 1 is suitable as a family album terminal.

In FIG. 12, the folders in the bottom row store processed images. For example, images converted to painting-style are stored in the folder F15; images whose secret flags have been set to 1 are stored in folder F16; altered images are stored in folder F17; and favorite images are stored in folder F18.

In this folder configuration as well, a person who has inserted a memory card into the image display device is identifiable through facial recognition, these folders may be provided as subfolders in the individual-specific folders in FIG. 5.

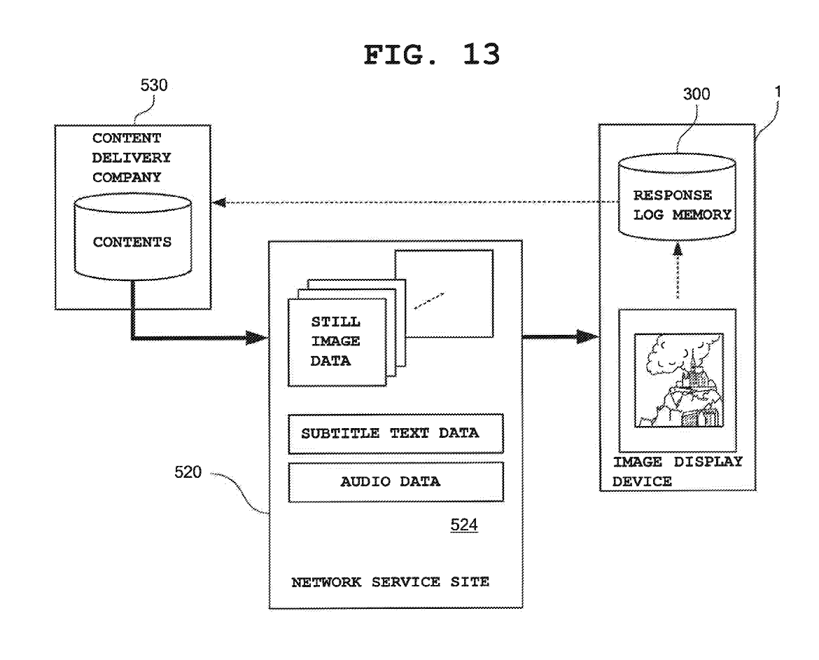

Next, FIG. 13 is a block diagram of showing an example of a content delivery service via a network which is related to an image delivery system according to the first embodiment. Reference numeral 1 indicates the image display device in FIG. 2, and reference numeral 520 indicates the network service site in FIG. 3. Reference numeral 530 indicates the delivery content site also in FIG. 3.

Contents delivered from the delivery content site 530 are composed of data for a plurality of still images, subtitle text data, and audio data. These contents are basically placed from the delivery content site 530 into the content server 524, and then displayed on the liquid crystal display panel 3 of the image display device 1. The image display device 1 may display only a still image, or may show a subtitle text over the still image and play sounds and music.

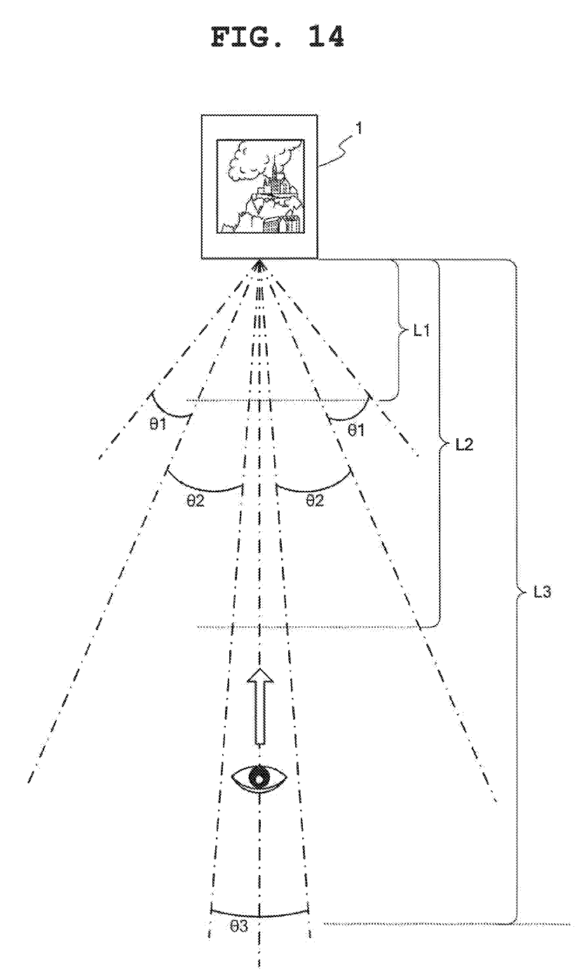

FIG. 14 is a conceptual diagram for explaining the analysis of log information that characterizes the first embodiment. The CPU 11 analyzes an image of a user (viewer) captured by the image sensor 8 and calculates angle-of-viewing information and distance information of the viewer viewing an image being displayed on the liquid crystal display panel 3. As described in FIG. 4, the number of views by the viewer can be counted for each image or each content based on facial recognition. Here, a concept referred to as interest indicator will be introduced.

In FIG. 14, the CPU 11 determines the angle θ1, θ2, or θ3 from which the viewer views the image display device 1, and the distance L1, L2, or L3 between the viewer and the image display device 1, from imaging results by the image sensor 8. Then, the CPU 11 analyzes the amount of attention paid to the content from the determined angle and the determined distance, and reflects the amount of attention in the log information as the above-described interest indicator. When the face of a viewer, and the distance, angle, and movement of the viewer in relation to the liquid crystal display panel 3 are recognized in addition to his viewing duration and number of views, various interest indicators can be acquired.

Regarding movement in relation to the liquid crystal display panel 3, for example, a change from angle θ1 to angle θ3 in the viewer's angle of viewing in relation to the liquid crystal display panel 3 when the viewer is focusing on the content, and a change from distance L3 to distance L2 in the viewer's viewing distance in relation to the liquid crystal display panel 3, which have been acquired by facial recognition, are converted to algorithms and reflected in the log information as interest indicators for the content.

Here, a configuration may be adopted in which facial recognition on the family members of the owner is performed in advance, and information regarding what content each person has viewed and how long the person has viewed are reflected in log information. Alternatively, a configuration may be adopted in which the face expressions of the family members are recognized in advance, and information regarding their reactions (laughing, showing interest, or expressing surprise) when they are viewing contents are reflected in log information. In addition, the family members' duration of stay in the setting location of the image display device 1, such as one day, one week, or the like, may be reflected in log information. Moreover, whether or not an operation for registering the content as a favorite has been performed, whether or not an operation for displaying the content in full screen has been performed, and the like may be reflected as interest indicators, in addition to recognition information.

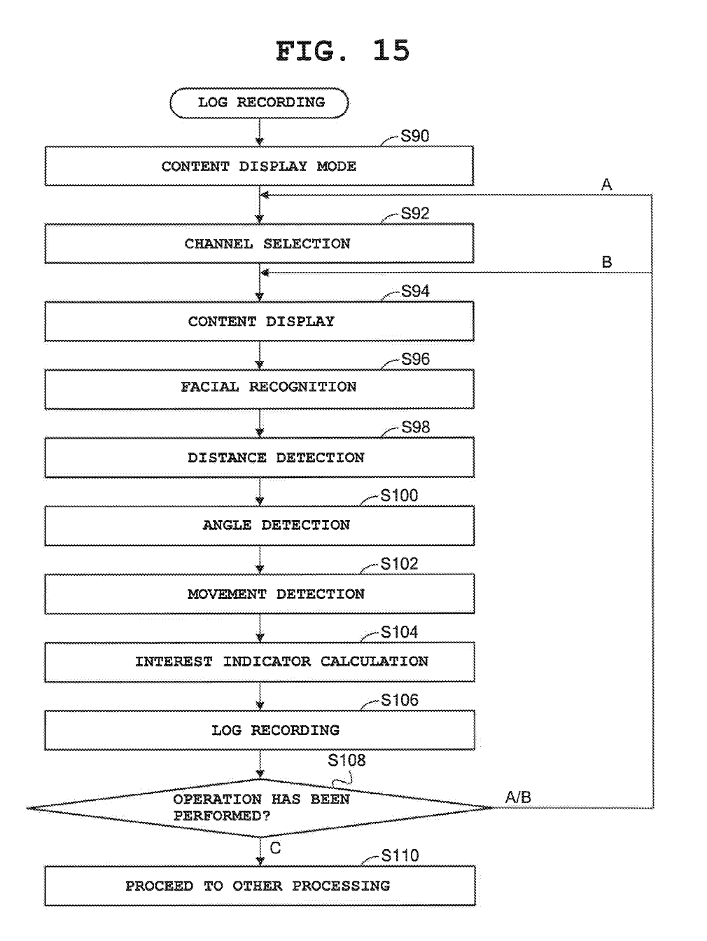

FIG. 15 is a flowchart outlining the operation of log recording performed in the image display device 1 according to the first embodiment. The flowchart is described under an assumption that the image display device 1 is connected to a network by wireless LAN or the like. First, the CPU 11 sets the image display device 1 in a content display mode (Step S90). In the content display mode, contents delivered from the delivery content site 530 are received and displayed. For example, a weather forecast channel, a fashion channel, a fashion advice channel, a stock report channel, a live camera channel and the like are provided. The content information is temporarily stored in the content server 524 of the network service site 520 and then downloaded to the image display device 1 via the communication control section 30, as described in FIG. 13.

Next, the CPU 11 prompts the user to select a desired channel (Step S92). When the user selects a channel, the CPU 11 displays a predetermined page of the selected channel (Step S94). Next, the image sensor 8, which is basically capturing images constantly, recognizes the face of the operator (viewer) by the facial recognition engine 100 (Step S96). Then, the CPU 11 determines, by calculation, the distance to the viewer and an angle from a vertical direction (the front when viewed from the screen) indicating the viewer's viewing direction (Step S98 and Step S100). In addition, when the recognized face moves, the CPU 11 detects the moving distance and the angle of the movement (Step S102). When the viewing direction of the viewer changes from angle θ1 to angle θ3 as shown in FIG. 14, the CPU 11 determines that the user has moved from a position at an angle to the imaging display device 1 to the front of the image display device 1, and therefore regards the interest indicator as being high. The CPU 11 also regards the interest indicator as being high when the distance between the image display device 1 and the viewer changes from distance L3 to distance L1, since this change indicates that the user has approached the screen.

Then, the CPU 11 combines the above-described information and thereby calculates the interest indicator (Step S104). There are various methods of calculating the interest indicator. For example, the interest indicator of the content for the “father” having the individual identification code “1001” is dependent on “number of views”, “viewing duration”, “angle of viewing”, “movement during viewing”, “favorite registration operation”, and “full-screen display operation.” Next, the CPU 11 records the interest indicator in the response log memory 300 as log information (Step S106).

In this state, the CPU 11 judges whether or not any operation has been performed (Step S108). For example, when judged that an operation for selecting another channel has been performed, the CPU 11 returns to Step S92 (A). When judged that an operation for designating another screen of the same channel has been performed, the CPU 11 returns to Step S94 (B). When other operations are performed, the CPU 11 proceeds to a processing flow corresponding to the operation (C at Step S110).

The above-described log information is important for the network service site 520 to determine which content to purchase and how it should be displayed. For the delivery content site 530, the log information is important in terms of content creation and deciding its amount. In addition, a configuration may be adopted in which the face of a viewer is recognized and the content that interests the viewer is automatically displayed.

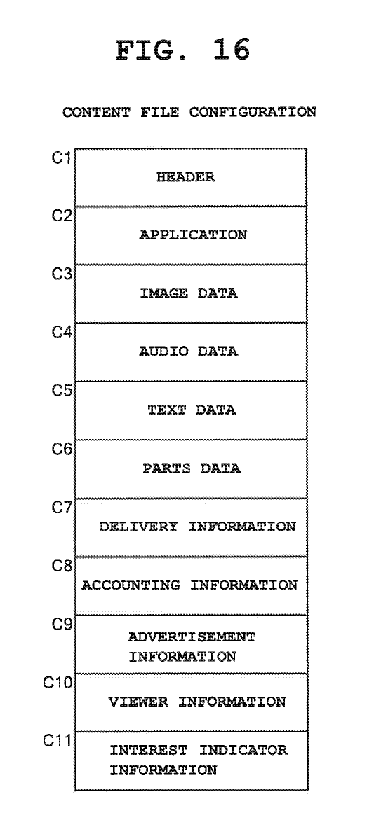

FIG. 16 is a conceptual diagram showing an example of the file configuration of content delivered from the delivery content site 530 and temporarily stored in the content server 524 of the network service site 520, in the first embodiment. Reference numeral C1 is a header in which data indicating the features of the content file itself, such as delivery company information, data type, and data size, are written. Reference numeral C2 is an application in which, when the content runs through a program, the program is written. For example, the program is Adobe Flash (registered trademark), or Java (registered trademark). Reference numeral C3 is a data portion that is the main body of the content and actually displayed. Reference numeral C4 is audio data. Reference numeral C5 is text data including subtitles such as that shown in FIG. 16. Reference numeral C6 is parts data that is used by the application C2. Reference numeral C7 is delivery information including delivery destination, delivery time, etc. Reference numeral C8 is accounting information that is necessary if the content is a paid content. Reference numeral C9 is advertisement information that is used if advertisements are included.

Reference numeral C10 is viewer information including individual identification codes that are recognition results as described above. Reference numeral C11 is interest indicator information calculated from “number of views”, “viewing duration”, “angle of viewing”, “movement during viewing”, “favorite registration operation” and “full-screen display operation”, as described above. The viewer information C10 and the interest indicator information C11 are stored in the response log memory 300, along with the header C1 that identifies the content.

In the first embodiment, authentication is performed by the image sensor 8. However, this authentication can be performed by incorporating a fingerprint authentication technology or a vein pattern authentication technology in the touch panel 5 or a button section. In the analysis of log information by fingerprint authentication or vein pattern authentication, for example, a button assigned to an individual is provided and information regarding the time of channel selection is created. Alternatively, window selection state of guidance information sent from the content delivery side, such as whether the viewer has closed an advertisement window or clicked on the window and viewed its detailed information, is reflected in the log analysis. Alternatively, information is acquired regarding who has pressed a stop button or a download button and for which content it has been pressed. The information acquired as described above can also be included in the interest indicator.

According to the first embodiment of the invention, an image considered to be highly interesting to a user can be identified from among numerous images, based on the interest indicator. Although a person to whom such images are transmitted may have a different degree of interests, this person's directionality of interest can be considered similar to the sender if the relationship between this person and the sender is, for example, that of a grandchild's household and the grandparents' household. Accordingly, especially when the user is a grandchild's household and viewing images for the purpose of transmitting them to the grandparents' household, transmitting images having high interest indicators to the grandparents' household is effective.

### B. Second Embodiment

Next, a second embodiment of the present invention will be described.

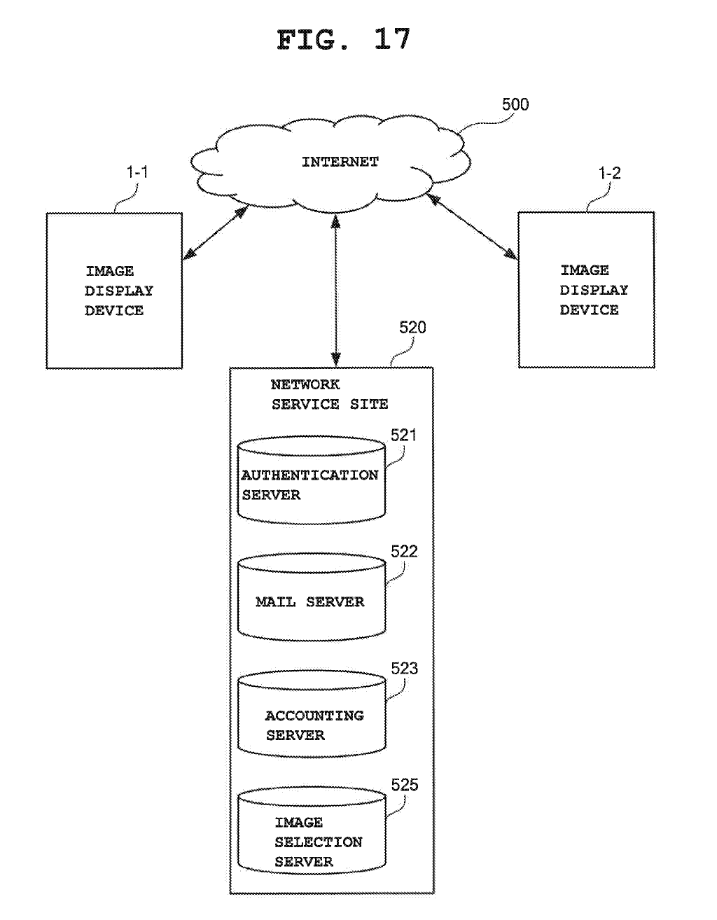

FIG. 17 is a block diagram showing the configuration of a network system centering on the network service site 520 in FIG. 3, to which the image display device 1 according to the second embodiment is applied. Sections corresponding to those in FIG. 3 are given the same reference numerals and so explanations thereof are omitted. In FIG. 17, reference numerals 1-1 and 1-2 represent image display devices that are connected to the Internet 500 via a communication control section 30 through the wireless LAN 32 or the like. The second embodiment will be described on the basis that image transfer is performed between distant locations, such as a grandchild and his parents (grandchild's household) and the grandparents (grandparents' household) living at a distance from the grandchild's household. The image display device 1-1 is set in the grandchild's household, and the image display device 1-2 is set in the grandparents' household.

The network service site 520 has a configuration similar to that in FIG. 3 described above. In the second embodiment, the network service site 520 collectively receives image data from the image display device 1-1 and transmits, as an e-mail attachment, images that satisfy predetermined conditions to the image display device 1-2 when necessary. Therefore, the network service site 502 includes an image selection server 525 (image selection section, delivery section, extraction section, first transfer control section, and second transfer control section) as one of the content servers 524 shown in FIG. 3. The image selection server 525 selects an image that satisfies a predetermined condition from among collectively received images.

When the grandchild's household takes photographs with a digital camera or the like, and transmits the large number of photographs accumulated in the image display device 1-1 in their entirety to the image display device 1-2 of the grandparents' household without sorting them, images unrelated to the grandparents' household are needlessly transmitted. Although random selection can be performed here, uninteresting photographs may be delivered to the grandparents' household. To avoid this problem, the grandchild's household may sort the large number of photographs to select photographs showing the grandchild and transmit them. However, the sorting operation is time-consuming, and therefore requires a sorting operation which creates a problem in that it causes the grandchild and the parents, who are busy with daily life, to stop using the system.

Therefore, in the second embodiment, after the image display device 1-1 collectively transmits a large number of accumulated photographs to the image selection server 525 of the network service site 520, the image selection server 525 selects a single photograph that satisfies predetermined conditions from the plurality of photographs, and delivers it to the image display device 1-2 of the grandparents' household as an e-mail attachment everyday. As a result, the grandparents' household receives a different photograph showing the grandchild's household every day by e-mail, whereby an enjoyable part of their everyday life increases and they can live a more enriched life.

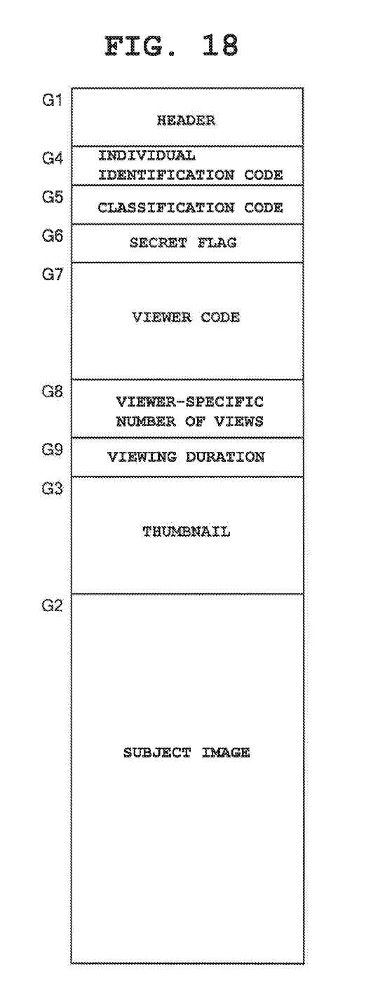

FIG. 18 is a conceptual diagram showing the structure of an image file stored in the memory card 60 of the image display device 1-1 according to the second embodiment. As described above, each image file conforms to the file format of a typical digital camera and includes the header G1 having data in EXIF or the like, the image data G2 of an original captured image, and the image data of the thumbnail G3 that is a reduced image of the image data G2. As data unique to the second embodiment, G9 stores the viewing duration of the image.

Hereafter, specific operations of the image display devices 1-1 and 1-2, and the network system according to the second embodiment will be described with reference to flowcharts. To simplify the descriptions, the flowcharts are expressed in accordance with operation procedures performed by the operator, and operation of the circuits and data movement will be described in association therewith.

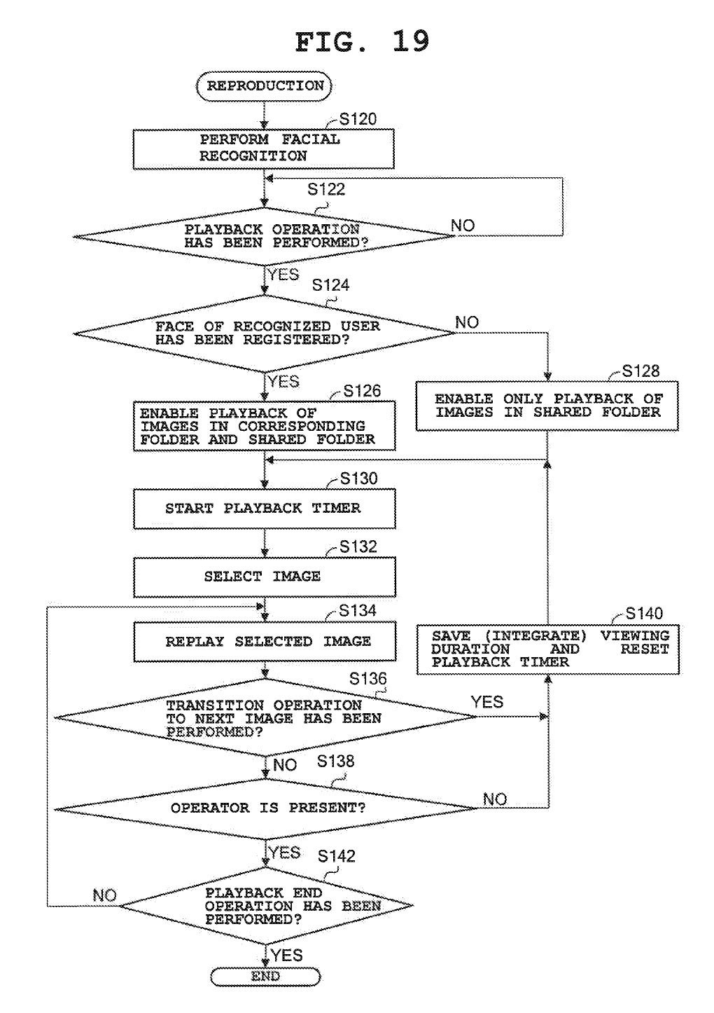

FIG. 19 is a flowchart for explaining a playback operation of the image display device 1-1 according to the second embodiment. When the user (or the operator: both registered and unregistered users are included therein) comes to the front of the image display device 1-1 to replay an image, since the image sensor 8 is capturing images, the CPU 11 and the facial recognition engine 100 operate cooperatively to recognize the operator's face (Step S120). Next, the CPU 11 judges whether or not a playback operation has been performed (Step S122). When judged that a playback operation has been performed, the CPU 11 judges whether or not the user, whose face has been recognized, has been registered (Step S124).

When judged that the face has been registered, since the user can be assumed to be a user of the image display device 1-1, the CPU 11 enables the playback of images in the corresponding folder. For example, if the user here is the father, images saved in the father's folder F1 and images stored in the shared folder F6 can be recognized (Step S126). Other people's folders such as the mother's folder F2 and the sister's folder F4 cannot be replayed. Conversely, when judged that the face has not been registered, the CPU 11 enables only the playback of the images saved in the shared folder F6 (Step S128).

Here, the facial recognition engine 100 can recognize the faces of a plurality of users shown in an image captured by the image sensor 8, and therefore the contents of the mother's folder F2 can also be replayed if the mother is also shown in the image showing the father. Next, the CPU 11 starts a playback timer (Step S130) and selects an image from the corresponding folder (Step S132). Then, the CPU 11 replays (displays) the selected image on the liquid crystal display panel 3 (Step S134). The playback timer measures the viewing duration of the image.

During the playback of the image, the CPU 11 judges whether or not a transition operation for replaying a next image has been performed (Step S136), whether or not the operator is present (Step S138), and whether or not a playback end operation has been performed (Step S142).

When judged that a transition operation for replaying a next image has been performed (YES at Step S136), the CPU 11 stores the time measured by the playback timer, namely the viewing duration, in the image file (see FIG. 18), and resets the playback timer (Step S140). Next, the CPU 11 returns to Step S130 and replays the next image.

Even during the playback of the image in the image display device 1-1, the image sensor 8 is capturing images of the operator, and accordingly the CPU 11 and the facial recognition engine 100 operate cooperatively to recognize the operator's face, thereby checking the presence of the operator. This is because the operator may leave the image display device 1-1 during the playback. When the user leaves (NO at Step S138), the CPU 11 saves the viewing duration measured by the playback timer in the image file (see FIG. 18) and resets the playback timer at Step S140, as described above.

When judged that the transition operation for replaying a next image has not been performed and the operator is present (NO at Step S136 and YES at Step S138), and further judged that a playback end operation has not been performed (NO at Step S142), the CPU 11 returns to Step S134 and continues the playback of the image. When judged that a playback end operation has been performed (YES at Step S142), the CPU 11 ends the processing.

The image display device 1-1 collectively transfers all images in a folder set in advance to the image selecting sever 525 at a predetermined timing or by user operation.

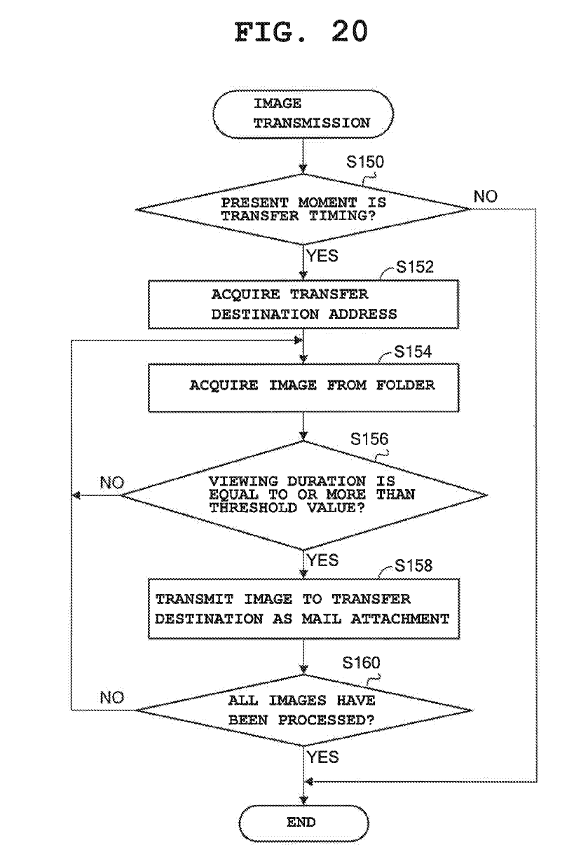

FIG. 20 is a flowchart for explaining an operation of an image selection server 525 according to the second embodiment. First, the image selection server 525 judges whether or not the present moment is a transfer timing (time or time interval set in advance) (for transferring an image to the grandparents' household) (Step S150). When judged that the present moment is not a transfer timing (NO at Step S150), the image selection server 525 ends the processing.

Conversely, when judged that the present moment is a transfer timing (YES at Step S150), the image selection server 525 acquires a transfer destination address (the image display device 1-2 of the grandparents' household) set in advance (Step S152), and acquires an image from a folder in which images received in advance have been stored (Step S154). The image selection server 525 then judges whether or not the viewing duration of the acquired image is equal to or more than a predetermined threshold value (Step S156). Here, the threshold value is, for example, 30 seconds or 1 minute.

When judged that the viewing duration of the image is not equal to or more than the predetermined threshold value (NO at Step S156), the image selection server 525 returns to Step S154 and performs the above-described judgment processing on a next image. Conversely, when judged that the viewing duration of the image is equal to or more than the predetermined threshold value, the image selection server 525 judges that the image has been viewed with interest, and transmits the image to the image display device 1-2 of the grandparents' household as an attachment to e-mail addressed to the transfer destination (Step S158). Next, the image selection server 525 judges whether or not all the images in the folder have been processed (Step S160). When judged that an unprocessed image exists (NO at Step S160), the image selection server 525 returns to Step S154 and performs the above-described judgment processing on the next image. Conversely, when judged that all the images have been processed (YES at Step S160), the image selection server 525 ends the processing.

In the above-described processing, images having a viewing duration that is equal to or more than the threshold value are sequentially transmitted to the image display device 1-2 of the grandparents' household at the transfer timing, from among the images in the folder. However, this is not limited thereto, and the transfer timing and the number of images to be transferred can be controlled as needed such that a single image is transmitted per day. In addition, the number of views may be used as the selection condition, instead of or in addition to the viewing duration.

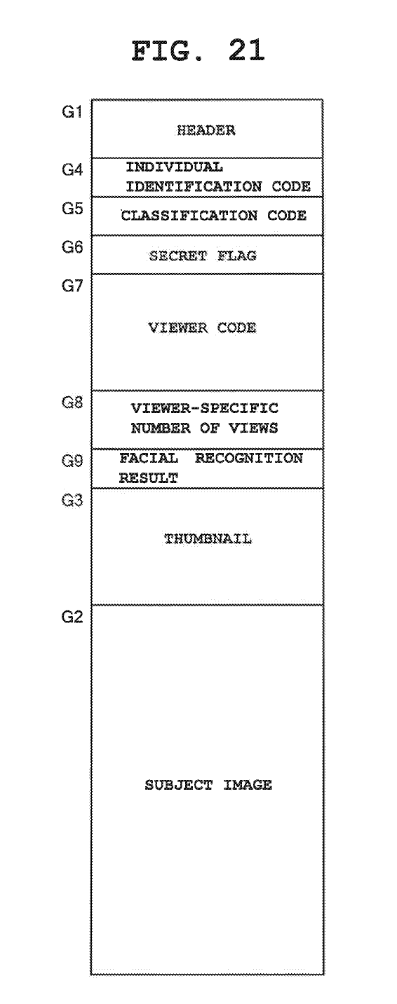

Also, in the second embodiment, images including the viewing duration information G9 in FIG. 18 are transmitted. However, the image that is attached to the e-mail at Step S158 in FIG. 21 may be the original image shown in FIG. 4.

As described above, in the second embodiment, the playback duration, namely the viewing duration, of an image is stored in the image file, whereby the extent to which the image has been viewed can be checked. Since a long viewing duration or a high number of views indicate that the degree of interest in the image is high, the possibility that the image will interest the grandparents' household as well is also high. Also, in the second embodiment, the image display device 1-1 of the grandchild's household collectively transmits images to the image selection server 525. Then, the image selection server 525 selects images to be transmitted to the image display device 1-2 of the grandparents' household based on the viewing durations and the numbers of views, and transmits the selected images. As a result, the image display device 1-2 of the grandparents' household receives different interesting images (such as photographs showing the grandchild) everyday by e-mail, whereby an enjoyable part of their every day life increases and they can live a more enriched life.

### C. Third Embodiment

Next, a third embodiment of the present invention will be described.

In the second embodiment, images to be transmitted to the image display device 1-2 of the grandparents' household are selected based on the viewing duration thereof. However, in the third embodiment, facial recognition is performed on images, and images to be transmitted to the image display device 1-2 of the grandparents' household are selected based on results of the facial recognition. For example, when images showing the grandchild's face are selected, a different image showing grandchild's face (such as photographs showing the grandchild's household) can be transmitted every day. Note that the configuration of the image delivery system is the same as that in FIG. 17, and so explanation thereof is omitted.

FIG. 21 is a conceptual diagram showing the structure of an image file stored in the memory card 60 of the image display device 1-1 according to the third embodiment. As described above, each image file conforms to the file format of a typical digital camera and includes the header G1 having data in EXIF or the like, the image data G2 of an original captured image, and the image data of the thumbnail G3 that is a reduced image of the image data G2. As data unique to the third embodiment, G9 stores a facial recognition result of the image. Specifically, G9 stores the individual identification code of a person (or those of people) included (shown) in the image as a result of facial recognition.

Hereafter, specific operations of the image display devices 1-1 and 1-2, and the network system according to the third embodiment will be described with reference to flowcharts. To simplify the descriptions, the flowcharts are expressed in accordance with operation procedures performed by the operator, and operation of the circuits and data movement will be described in association therewith.

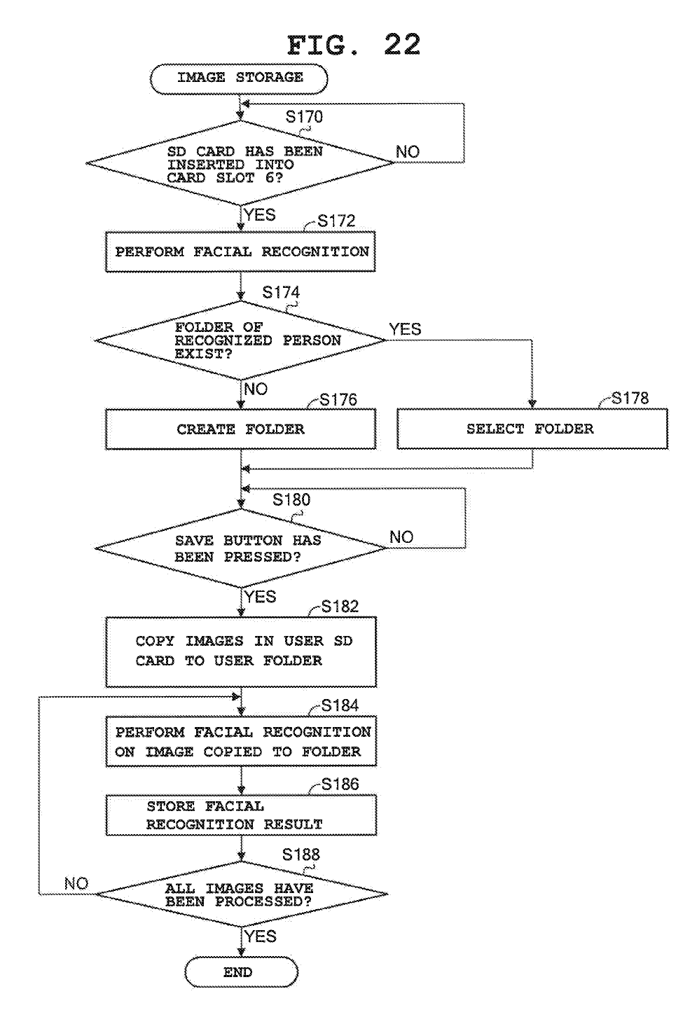

FIG. 22 is a flowchart of procedures performed in the image display device 1-1 according to the third embodiment when the memory card 60, such as an SD card, is inserted into the memory card slot 6 and images in the memory card 60 are stored in the internal memory 14. First, the CPU 11 judges whether or not the memory card 60 has been inserted into the memory card slot 6 (Step S170). When judged that the memory card 60 has been inserted in the memory card slot 6, the CPU 11 performs facial recognition on the face of the user currently being captured by the image sensor 8, using the facial recognition engine 100 (Step S172).

Next, the CPU 11 judges whether or not an individual identification code has been registered for the face on which facial recognition has been performed (Step S174). When the user is a new user whose folder does not exist, the CPU 11 issues a new identification code, and after registering the user's face, creates a folder (Step S176). Conversely, when the user operating the image display device 1 is, for example, the father having the identification code “1001”, the CPU 11 selects the folder F1 (Step S178). Note that a configuration may be adopted where images cannot be saved by unregistered users.

Next, the CPU 11 judges whether or not a save button displayed on the liquid crystal display panel 3 has been pressed (Step S180). When judged that the save button has been pressed via the touch panel 5, the CPU 11 copies images recorded on the memory card 60 to the corresponding folder (Step S182). That is, the user (operator) can save images in his own folder without being particularly conscious of it. Then, the creation of subfolders based on classifications in the folder and the setting of the secret flag are performed as necessary, according to a menu.

Next, the CPU 11 performs facial recognition on an image copied to the folder (Step S184) and stores its facial recognition result in the image file (Step S186). For example, the individual identification code of the grandchild is stored for an image showing the grandchild's face. Next, the CPU 11 judges whether or not all the images in the folder have been processed (Step S188). When judged that an unprocessed image exists (NO at Step S188), the CPU 11 returns to Step S184 and performs the above-described facial recognition processing on the next image. Conversely, when judged that all the images have been processed (YES at Step S188), the CPU 11 ends the processing. As a result, a person or people included (captured) in each image can be recognized.

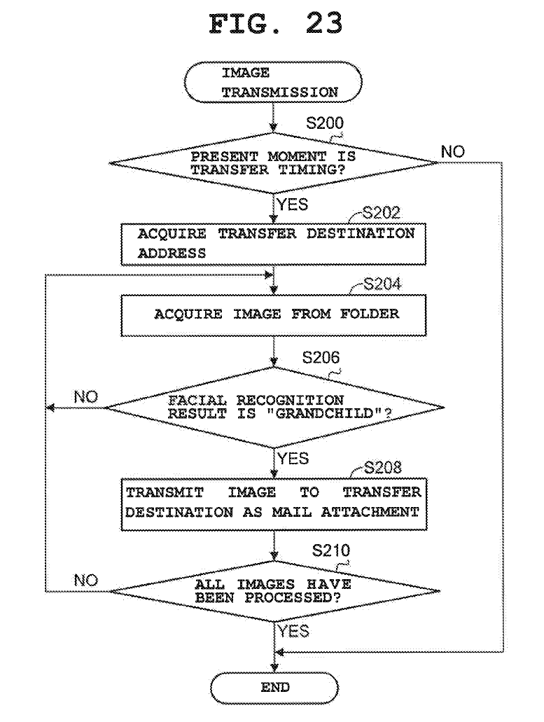

FIG. 23 is a flowchart for explaining an operation of the image selection server 525 according to the third embodiment. First, the image selection server 525 judges whether or not the present moment is a transfer timing (time or time interval set in advance) (for transferring an image to the grandparents' household) (Step S200). When judged that the present moment is not a transfer timing (NO at Step S200), the image selection server 525 ends the processing.

Conversely, when judged that the present moment is a transfer timing (YES at Step S200), the image selection server 525 acquires a transfer destination address (the image display device 1-2 of the grandparents' household) set in advance (Step S202), and acquires an image from a folder in which images received in advance have been stored (Step S204). The image selection server 525 then judges whether or not “grandchild”, for example, is included in the facial recognition result of the acquired image (Step S206).

When judged that “grandchild” is not included in the facial recognition result of the image (NO at Step S206), the image selection server 525 returns to Step S204 and performs the above-described judgment processing on the next image. Conversely, when judged that “grandchild” is included in the facial recognition result of the image, the image selection server 525 transmits the image to the image display device 1-2 of the grandparents' household as an attachment to e-mail addressed to the transfer destination (Step S208). Next, the image selection server 525 judges whether or not all the images in the folder have been processed (Step S210). When judged that an unprocessed image exists (NO at Step S210), the image selection server 525 returns to Step S204 and performs the above-described judgment processing on the next image. Conversely, when judged that all the images have been processed (YES at Step S210), the image selection server 525 ends the processing.

In the above-described processing, images including the face of the “grandchild” are sequentially transmitted to the image display device 1-2 of the grandparents' household at the transfer timing, from among the images in the folder. However, this is not limited thereto, and the transfer timing and the number of images to be transferred can be controlled as needed such that a single image is transmitted per day.

Also, in the third embodiment, images including the facial recognition information G9 in FIG. 21 are transmitted. However, the image that is attached to the e-mail at Step S208 in FIG. 23 may be the original image shown in FIG. 4.

Additionally, in the third embodiment, the image display device 1-1 performs facial recognition on images and stores the facial recognition results. However, this is not limited thereto, and a configuration may be adopted in which the image display device 1-1 simply collectively transmits images to the image selection server 525, and the image selection server 525 performs facial recognition on each of the received images, and selects images to be transmitted to the image display device 1-2 of the grandparents' household based on the facial recognition results.

In the third embodiment, images that are to be transmitted are differentiated by being transmitted to the image selection server 525 (storage area is changed: images are moved) at the points when they are judged as images that are to be transmitted based on the facial recognition results. Therefore, the areas G8 and G9 for storing an interest indicator, the number of views, and the like in an image file are unnecessary.

As described above, in the third embodiment, the image display device 1-1 of the grandchild's household performs facial recognition processing on images and stores the facial recognition results in the image files. Then, the image selection server 525 selects images to be transmitted to the image display device 1-2 of the grandparents' household based on the facial recognition results and transmits the selected images. As a result, the image display device 1-2 of the grandparents' household receives different interesting images (such as photographs showing the grandchild) everyday by e-mail, whereby an enjoyable part of their every day life increases and they can live a more enriched life.

### D. Fourth Embodiment

Next, a fourth embodiment of the present invention will be described.

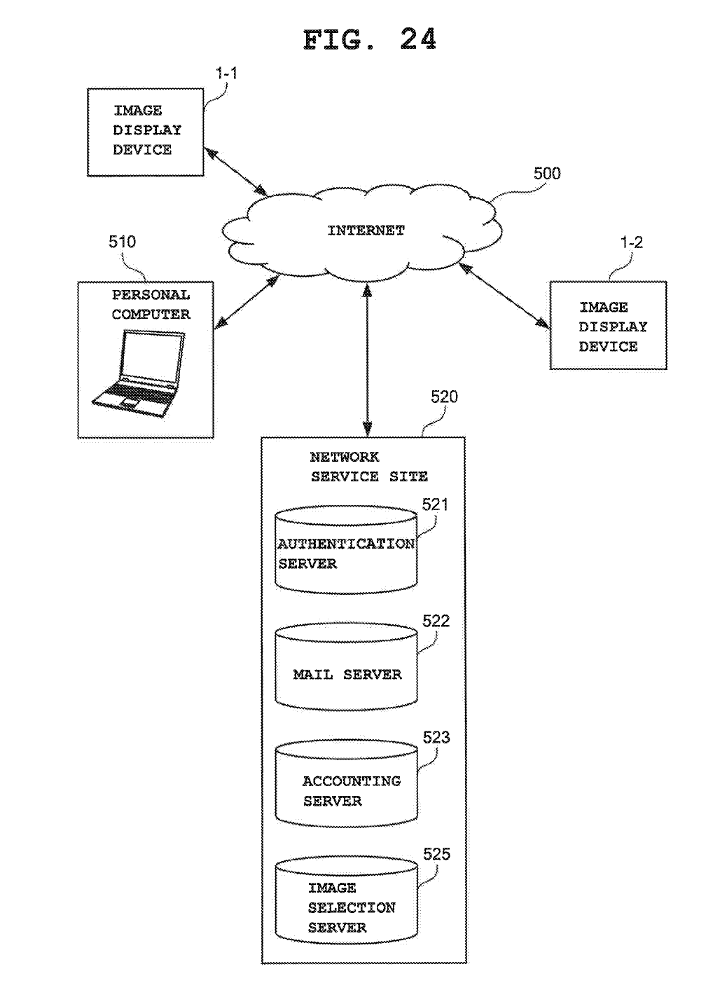

FIG. 24 is a block diagram showing the configuration of a network system to which the image display device 1-2 according to the fourth embodiment is applied. Sections corresponding to those in FIG. 17 are given the same reference numerals and so explanations thereof are omitted. Reference numeral 510 indicates a personal computer that can be connected to the image display device 1-1 via the communication control section 30 by the wireless LAN 32 or the like. Through this personal computer 510, image editing (image alterations and image processing) which cannot be performed by the image display device 1 can be performed.

The personal computer 510 according to the fourth embodiment performs image editing on an image stored in the image display device 1-1, and stores the editing history (the editing duration or the number of the edits, both of which are integrated values) of the edited image in the image file. The network service site 520 according to the fourth embodiment includes the image selection server 525. The image selection server 525 collectively receives image data from the image display device 1-1, after selecting images based on the editing histories (the editing durations or the numbers of edits), transmits the selected images to the image display device 1-2 as an e-mail attachment.

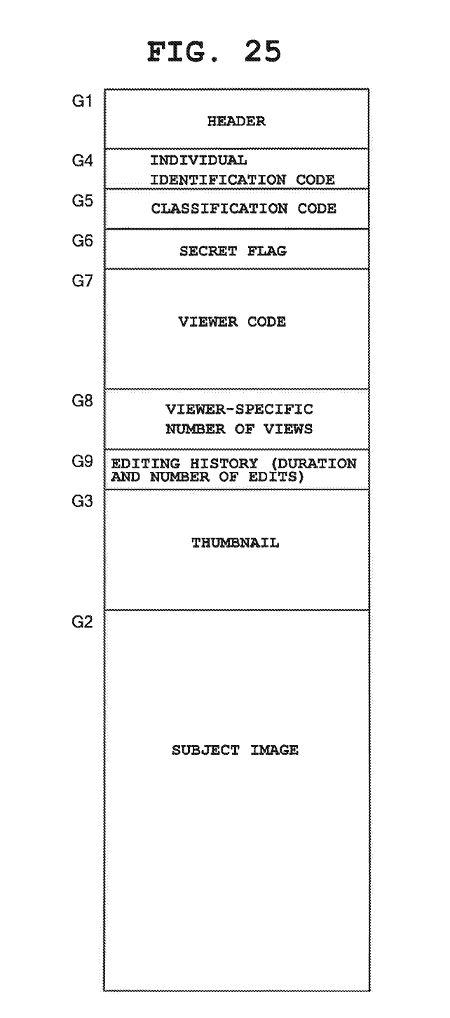

FIG. 25 is a conceptual diagram showing the structure of an image file stored in the memory card 60 in the image display device 1-1 according to the fourth embodiment. As described above, each image file conforms to the file format of a typical digital camera and includes the header G1 having data in EXIF or the like, the image data G2 of an original captured image, and the image data of the thumbnail G3 that is a reduced image of the image data G2. As data unique to the fourth embodiment, G9 stores the editing history (the editing duration or the number of edits) of the image.

Hereafter, specific operations of the image display devices 1-1 and 1-2, and the network system according to the fourth embodiment will be described with reference to flowcharts. To simplify the descriptions, the flowcharts are expressed in accordance with operation procedures performed by the operator, and operation of the circuits and data movement will be described in association therewith.

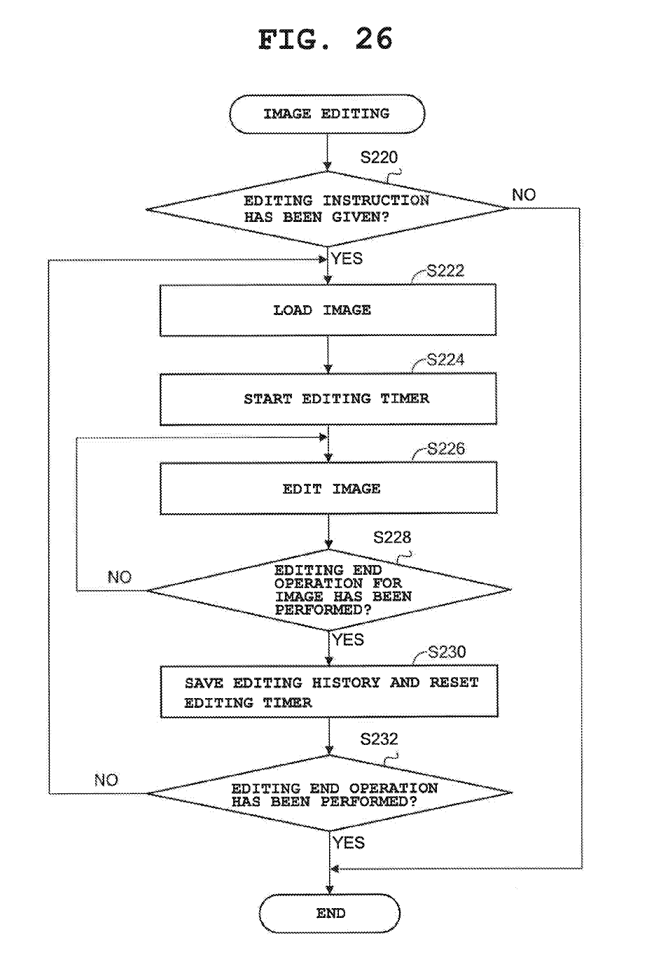

FIG. 26 is a flowchart for explaining an editing operation of the personal computer 510 according to the fourth embodiment. First, the personal computer 510 judges whether or not an image editing instruction has been given by a user (Step S220). When judged that an editing instruction has not been given (NO at Step S220), the personal computer 510 ends the processing. Conversely, when judged that an editing instruction has been given (YES at Step S220), the personal computer 510 connects to the image display device 1-1 via the communication control section 30 by wireless LAN 32 or the like, and loads an image (designated by the user) from the image display device 1-1 (Step S222). Next, the personal computer 510 starts an editing timer (Step S224). This editing timer is used to measure the amount of time required for performing editing processing on the image.

Next, the personal computer 510 performs image editing on the image in accordance with user operations (Step S226). During image editing, the personal computer 510 judges whether or not an editing end operation for the image has been performed (Step S228). When judged that an editing end operation for the image has not been performed (NO at Step S228), the personal computer 510 returns to Step S226 and continues the editing processing.

Conversely, when judged that an editing end operation for the image has been performed (YES at Step S228), the personal computer 510 stores the time measured by the editing timer (or the number of the edits) in the image file as an editing history, and resets the editing timer (Step S230). Next, the personal computer 510 judges whether or not an editing end operation has been performed by the user (Step S232). When judged that an editing end operation has not been performed (NO at Step S230), the personal computer 510 returns to Step S222 and performs editing processing on the next image. Conversely, when judged that an editing end operation has been performed, the personal computer 510 ends the processing.

The image display device 1-1 collectively transfers all images in a folder set in advance to the image selection server 525 at a predetermined timing or by user operation.

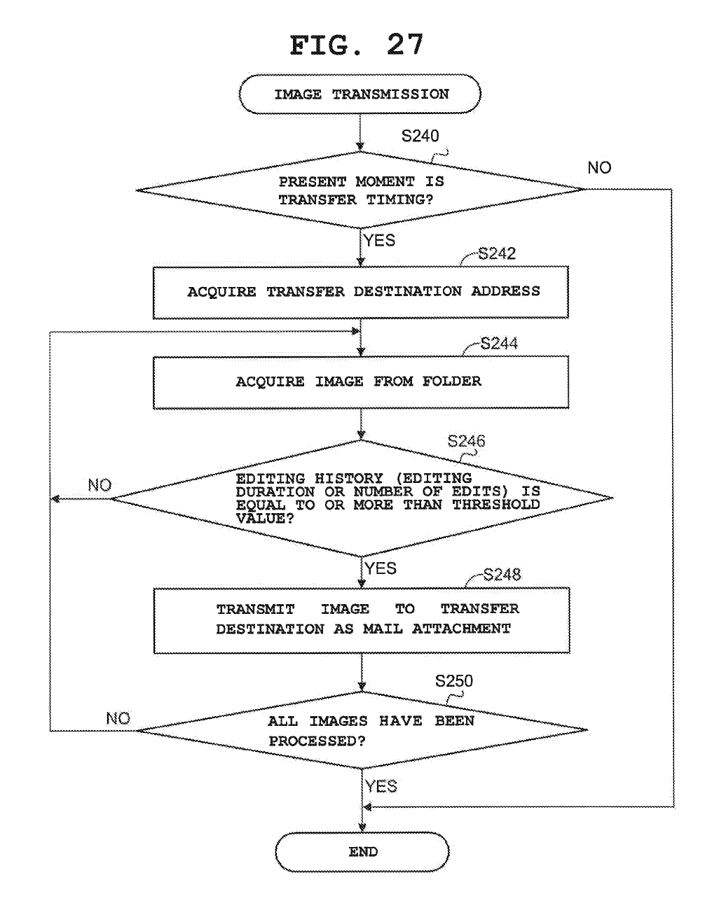

FIG. 27 is a flowchart for explaining an operation of the image selection server 525 according to the fourth embodiment. First, the image selection server 525 judges whether or not the present moment is a transfer timing (time or time interval set in advance) (for transferring an image to the grandparents' household) (Step S240). When judged that the present moment is not a transfer timing (NO at Step S240), the image selection server 525 ends the processing.

Conversely, when judged that the present moment is a transfer timing (YES at Step S240), the image selection server 525 acquires a transfer destination address (the image display device 1-2 of the grandparents' household) set in advance (Step S242), and acquires an image from a folder in which images received in advance have been stored (Step S244). The image selection server 525 then judges whether or not the editing history of the acquired image is equal to or more than a predetermined threshold value (whether or not the editing duration or the number of the edits is equal to or more than the predetermined threshold value) (Step S246). The threshold value herein is a value such as 30 minutes or 1 hour when the editing history is an editing duration, and a value such as 5 times or 10 times when the editing history is the number of edits.

Then, when judged that the editing history of the image is not equal to or more than the predetermined threshold (NO at Step S246), the image selection server 525 returns to Step S244 and performs the above-described judgment processing on the next image. Conversely, when judged that the editing history of the image is equal to or more than the predetermined threshold, the image selection server 525 judges that the image has been edited because it is interesting, and transmits the image to the image display device 1-2 of the grandparents' household as an attachment to e-mail addressed to the transfer destination (Step S248). Next, the image selection server 525 judges whether or not all the images in the folder have been processed (Step S250). When judged that an unprocessed image exists (NO at Step S250), the image selection server 525 returns to Step S244 and performs the above-described judgment processing on the next image. Conversely, when judged that all the images have been processed (YES at Step S250), the image selection server 525 ends the processing.

In the above-described processing, images whose editing histories are equal to or more than the threshold value are sequentially transmitted to the image display device 1-2 of the grandparents' householder at the transfer timing, from among the images in the folder. However, this is not limited thereto, and the transfer timing and the number of images to be transferred can be controlled as needed such that a single image is transmitted per day. Also, in the fourth embodiment, images including the editing history information G9 in FIG. 25 are transmitted. However, the image that is attached to the e-mail at Step S248 in FIG. 27 may be the original image shown in FIG. 4.

As described above, in the fourth embodiment, the editing history of an image is stored in the image file, whereby the extent to which the image has been edited can be checked. Since a long editing history (editing duration) or many editing histories (number of edits) indicates that the degree of interest in the image is high, the possibility that the image will interest the grandparents' household as well is also high. Also, in the fourth embodiment, the image display device 1-1 of the grandchild's household collectively transmits images to the image selection server 525. Then, the image selection server 525 selects images to be transmitted to the image display device 1-2 of the grandparents' household based on the editing histories, and transmits the selected images. As a result, the image display device 1-2 of the grandparents' household receives different interesting images (such as photographs showing the grandchild) everyday by e-mail, whereby an enjoyable part of their everyday life increases and they can live a more enriched life.

### E. Fifth Embodiment

Next, a fifth embodiment of the present invention will be described.

In the above-described first to fourth embodiments, an image file to be transmitted is selected based on the interest indicator, the number of views, the viewing duration, the editing history, or the like. Then, the interest indicator, the viewing duration, the number of views, the facial recognition result, the editing history, the number of copies, the number of prints, whether or not the image has been transferred to another device, the expression of the viewer acquired by facial recognition, or the like is stored in the image file. However, in the fifth embodiment, the above-described information is not stored in an image file to be sent. An image to be sent is sorted into a separate memory area, and the sorted image is transmitted to the grandparents' household at a predetermined timing. Note that the configuration of the image delivery system is the same as that in FIG. 17, and so explanation thereof is omitted. Additionally, in the explanation below, an interest indicator is used for image selection.

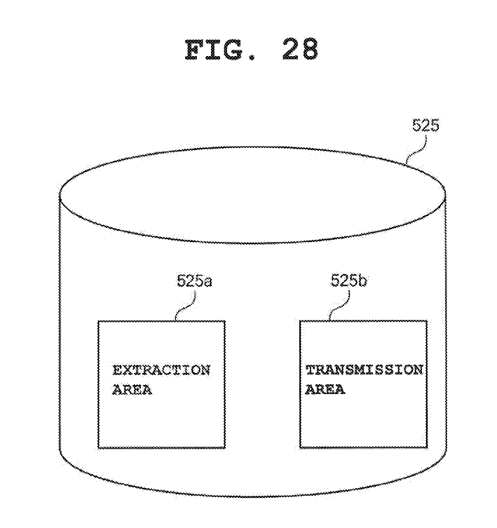

FIG. 28 is a block diagram showing the configuration of the image selection server 525 according to the fifth embodiment. The image selection server 525 includes an extraction area 525a (first storage area and second storage area) in which images extracted by the image display device 1-1 of the grandchild's household to be delivered to the grandparents are stored, and a transmission area 525b (third storage area) in which images delivered to the grandparents are stored.

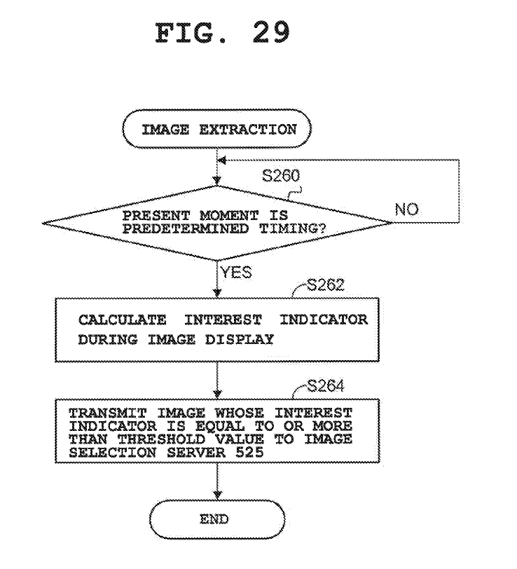

FIG. 29 is a flowchart for explaining an operation of the image display device 1-1 according to the fifth embodiment which is owned by the grandchild's household. First, the image display device 1-1 judges whether or not the present moment is a predetermined timing (Step S260). Here, the predetermined timing denotes a time when a user operation, such as the viewing, playback, or editing of an image stored in a predetermined folder, has been performed. Every time a change factor that changes an interest indicator or the like is generated, a result of the judgment is “YES” and therefore the image display device 1-1 proceeds to the next step. Note that this judgment may be performed periodically, such as once every hour, even when a change factor has not been generated.

When judged that the present moment is a predetermined timing (YES at Step S260), the image display device 1-1 calculates the interest indicators of images stored in the predetermined folder (Step S262) and transmits images whose interest indicators are equal to or more than a predetermined threshold to the image selection server 525 (Step S264).

Specifically, in an instance where an interest indicator is used, when an interest indicator is equal to or more than the threshold value at a timing at which it is recorded in the response log memory 300 at Step S106 in FIG. 15 in the first embodiment, the image display device 1-1 transmits the image to the image selection server 525.

Additionally, in an instance where a viewing duration is used, when a viewing duration is equal to or more than the threshold value at a timing at which it is stored in the image file at Step S140 in FIG. 19 in the second embodiment, the image display device 1-1 transmits the image to the image selection server 525.

Moreover, in an instance where a facial recognition result is used, when a facial recognition result includes “grandchild” at a timing at which it is stored in the image file at Step S186 in FIG. 22 in the third embodiment, the image display device 1-1 transmits the image to the image selection server 525.

Furthermore, in an instance where an editing history (editing duration or number of edits) is used, when an editing history (editing duration or number of edits) is equal to or more than the threshold value at a timing at which it is stored in the image file at Step S230 in FIG. 26 in the fourth embodiment, the image display device 1-1 transmits the image to the image selection server 525.

As a result of the above-described operations, every time an image accumulated in the image display device 1-1 is viewed, the interest indicator of the image is calculated. Then, when the interest indicator reaches the threshold value or more, the image is transmitted to the image selection server 525. That is, an image having a high interest indicator is transmitted to the image selection server 525 as an image to be sent to the grandparents' household.

As described above, when the configuration, in which an image is transferred to the image selection server 525 instead of the area G9 for interest indicators and the like being created, is adopted in the first to fourth embodiments, the interest indicator, the viewing duration, the facial recognition result, the editing history (editing duration or number of edits), and the like are no longer required to be stored in the image file.

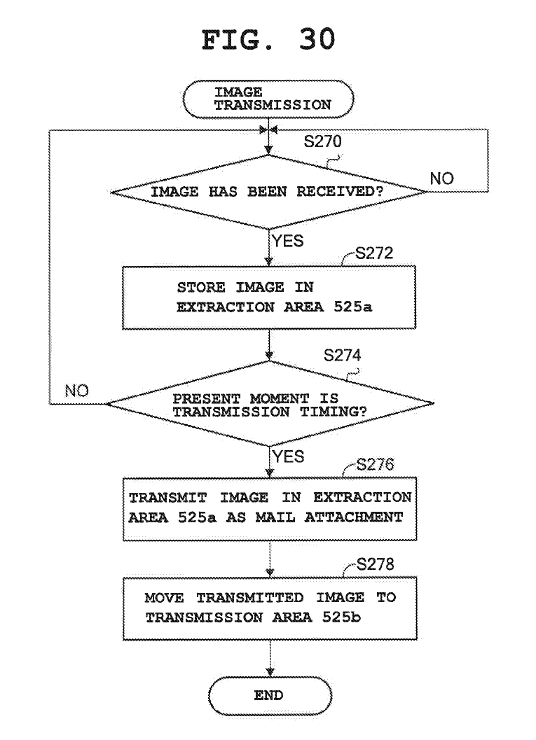

FIG. 30 is a flowchart for explaining an operation of the image selection server 525 according to the fifth embodiment. First, the image selection server 525 judges whether or not an image has been received from the image display device 1-1 (Step S270). When judged that an image has been received (YES at Step S270), the image selection server 525 stores the image in the extraction area 525a (Step S272).

Next, the image selection server 525 judges whether or not the current moment is a transmission timing for transmitting an extracted image to the grandparents (Step S274). The transmissions of extracted images may be synchronized with their extraction timing, or may be collectively performed at a predetermined time of a day of the week or a date set in advance, rather than their extraction timing. Alternatively, it may be performed at a timing at which the number of image files stored in the extraction area 525a reaches a predetermined number.

When judged that the current moment is not a transmission timing (NO at Step S274), the image selection server 525 returns to Step S270. Conversely, when judged that the current moment is a transmission timing (YES at Step S274), the image selection server 525 transmits the image stored in the extraction area 525a to the image-display device 1-2 of the grandparents' household as an e-mail attachment (Step S276). Then, the image selection server 525 moves the transmitted image from the extraction area 525a to the transmission area 525b (Step S278) and ends the processing.

The transmitted image is moved to the transmission area 525b as described above to prevent the same image from being redundantly stored. In addition, by the transmitted images being accumulated in the transmission area 525b, the user can recognize which images have been transmitted, and organize the images that are important (to the grandparents).

As described above, in the fifth embodiment, images that are to be transmitted are differentiated by being transmitted to the image selection server 525 (storage area is changed: images are moved) at the points when they are judged in the image display section 1-1 of the grandchild's household as images that are to be transmitted. Therefore, the area G9 for storing interest indicators and the like are unnecessary.

Also, in the fifth embodiment, images are transmitted to the image selection server 525 at the points when they are judged in the image display section 1-1 of the grandchild's household as images that are to be transmitted. Then, the image selection server 525 transmits the stored image files to the grandparents' household at a predetermined transmission timing. As a result of this configuration, images that are to be transmitted can be differentiated without information such as interest indicators being added to the image files that are to be transmitted.

Note that a configuration may be applied to the fifth embodiment, in which image identification information such as file names are recorded in a transmission area 525c, rather than transmitted images being moved to the transmission area 525b. In this configuration, some sort of flag or link information is required to differentiate transmitted images.

Also, for a plurality of images placed in the extraction area 525a, it needs to be determined in what order the images are transmitted to the grandparents at a transmission timing. For example, the order of written date, the order of captured date, the order of file names, random order, etc, can be used. The number of images to be sent in a single transmission is not limited to one, and a configuration may be adopted in which the number of images to be sent changes depending on the day; images stored in the extraction area 525a are transmitted at once; or images in the extraction area 525a are transmitted when a predetermined number of images are accumulated.

Additionally, in the fifth embodiment as well, an interest indicator, the number of views, a viewing duration, an editing history, or the like may be recorded in the image file itself, as in the case of the first to fourth embodiments.

In the above-described embodiments, an interest indicator, a viewing duration, the number of views, a facial recognition result, or an editing history is given as a condition for selecting an image to be transmitted. However, the selection condition is not limited thereto, and it may be the number of copies, the number of prints, whether or not a copy and display operation has been performed in the image display device 1-1 of the grandchild's household, whether or not the image has been transferred or copied to an own mobile phone in the grandchild's household and set as an idle screen, whether or not the image has been displayed on the personal computer 510 or the image display device 1-1 of the grandchild's household, the degree of smile acquired through facial recognition on the viewer captured by the image display device 1-1, and the like.

Additionally, in the first to fourth embodiments, examples have been described in which the selection of an image to be transmitted is made by the image selection server 525. However, the configurations of the first to fourth embodiments are not limited thereto, and a configuration may be adopted in which the image display device 1-1 selects an image, and the selected image is transmitted to the image selection server 525, as in the case of the fifth embodiment. In this configuration, the image selection server 525 only provides the delivery function.

Moreover, a configuration may be applied to the first to fifth embodiments in which all images are transmitted to the image selection server 525 in advance (for example, in folder units), and the interest indicators of the images in the image display device 1-1 of the grandchild's household are transmitted in real time to the image selection server 525 (the interest indicators are transmitted in association with the file names of the images). In this configuration, when an interest indicator is received, the image selection server 525 judges whether or not the received interest indicator is equal to or more than a threshold value. Then, when judged that the interest indicator is equal to or more than the threshold value, the image selection server 525 transmits the corresponding image to the image display device 1-2 of the grandparents' household. In this instance as well, images that are to be transmitted can be differentiated without information such as interest indicators being added to the image files that are to be transmitted.

Furthermore, in the first to fifth embodiments, the image display device 1-1 generates an interest indicator, a viewing duration, the number of views, a facial recognition result, or an editing history as a condition for selecting the image to be transmitted. However, the configurations of the first to fifth embodiments are not limited thereto, and a configuration may be adopted in which, if this is a case where an interest indicator is used, facial recognition results, distances, angles, movements, and the like are transmitted to the image selection server 525 in real-time, and the image selection server 525 calculates the interest indicator. In this instance as well, images that are to be transmitted can be differentiated without information such as interest indicators being added to the image files that are to be transmitted.

In the case of a still image captured by the still-in-movie function (a function for capturing a still image while recoding a video), a video captured at the time close to the shooting time of the still image may be analyzed. As a result of the analysis, if the video is that of a fun scene, it is highly likely that the still image is a fun image. Therefore, the still image may be selected as an image that is to be transmitted to the image display device 1-2 of the grandparents' household.

Similarly, in the case of a still image captured by the still-in-movie function which is showing the grandchild, a video captured at the time close to the shooting time of the still image may be analyzed as in the case above. As a result of the analysis, if the video is that of a fun scene, it is highly likely that the still image is a fun photograph centering on the grandchild. Therefore, the still image may be selected as an image that is to be transmitted to the image display device 1-2 of the grandparents' household.

The judgment of the above-described “fun scene” can be made based on a condition such as “whether or not the sound volume has increased (the volume of their laughter and voices has increased)” or “whether or not a person captured in the video is smiling”.

Note that images that the user does not want to transmit can be set as unselectable. For example, when the viewing duration of a photograph is long but a face shown therein does not look good (an angry face, a sad face, etc.), this photograph can be set not to be sent.

In the first to fifth embodiments, the SD card has been described as an example of the memory card 60. However, the memory card 60 is not required to be card-shaped as long as it is a memory medium. A hard disk drive may be connected by Universal Serial Bus (USB), and images stored in the hard disk drive may be downloaded.

While the present invention has been described with reference to the preferred embodiments, it is intended that the invention be not limited by any of the details of the description therein but includes all the embodiments which fall within the scope of the appended claims.

What is claimed is:

1. An image delivery system including an image display device, and a server that receives an image from the image display device via a network and delivers the received image to an other image display device for displaying the delivered image via the network, comprising:
an additional information generation section which generates additional information related to a result of an operation or processing performed on the image;
a storage control section which stores the additional information generated by the additional information generation section in association with the image;
an image selection section which selects an image to be transferred to the other image display device based on the additional information stored in association with the image by the storage control section; and
a delivery section which delivers the image selected by the image selection section to the other image display device.

2. The image delivery system according to claim 1, wherein the additional information generation section generates a viewing duration of the image as the additional information, and the image selection section selects an image to be delivered to the other image display device based on the viewing duration of the image.

3. The image delivery system according to claim 1, wherein the additional information generation section generates the number of views of the image as the additional information, and the image selection section selects an image to be delivered to the other image display device based on the number of views of the image.

4. The image delivery system according to claim 1, wherein the additional information generation section generates a result of facial recognition performed on the image as the additional information, and the image selection section selects an image to be delivered to the other image display device based on the result of the facial recognition performed on the image.

5. The image delivery system according to claim 1, wherein the additional information generation section generates an editing history of the image as the additional information, and the image selection section selects an image to be delivered to the other image display device based on the editing history of the image.

6. The image delivery system according to claim 1, wherein the additional information generation section generates any one of the number of copies of the image, the number of prints of the image, information regarding whether or not of the image has been transferred to the other device, and a facial expression of a viewer viewing the image which is determined by facial recognition, as the additional information; and
the image selection section selects an image to be delivered to the other image display device based on any one of the number of copies of the image, the number of prints of the image, the information regarding whether or not of the image has been transferred to the other device, and the facial expression of the viewer viewing the image which is determined by facial recognition.

7. An image display device that displays an image and transfers the image via a network to a server that delivers the image to an other display device for displaying the delivered image, comprising:
an additional information generation section which generates additional information related to a result of an operation or processing performed on the image;
a storage control section which stores the additional information generated by the additional information generation section in association with the image; and
a transfer section which transfers to the server the image with which the addition information has been stored in association.

8. The image display device according to claim 7, wherein the additional information generation section generates any one of a viewing duration of the image, the number of views of the image, a result of facial recognition performed on the image, an editing history of the image, the number of copies of the image, the number of prints of the image, information regarding whether or not of the image has been transferred to the other device, and a facial expression of a viewer viewing the image which is determined by facial recognition, as the additional information.

9. An image delivery server that receives an image via a network from an image display device that displays an image, and delivers the received image to an other image display device via the network, comprising;
an image selection section which selects an image to be delivered to the other image display device based on additional information stored in association with the image; and
a delivery section which delivers the image selected by the image selection section to the other image display device.

10. The image delivery server according to claim 9, wherein the additional information is any one of a viewing duration of the image, the number of views of the image, a result of facial recognition performed on the image, an editing history of the image, the number of copies of the image, the number of prints of the image, information regarding whether or not of the image has been transferred to the other device, and a facial expression of a viewer viewing the image which is determined by facial recognition.

11. An image delivery system including an image display device that displays an image, and a server that receives an image from the image display device via a network and delivers the received image to an other image display device via the network, comprising:
an image selection section which selects an image to be transferred to the other image display device based a result of an operation or processing performed on the image; and
a delivery section which delivers the image selected by the image selection section to the other image display device for displaying the delivered image.

12. The image delivery system according to claim 11, wherein the image selection section moves an image selected as the image to be delivered to the other image display device based on the result of an operation or processing performed on the image to a predetermined storage area, and stores the image in the predetermined storage area; and
the delivery section delivers the image that has been moved to the predetermined storage area by the image selection section to the other image display device.

13. The image delivery system according to claim 12, wherein the delivery section moves the image that has been delivered to the other image display device to a delivered image storage area and stores the image in the delivered image storage area.

14. The image delivery system according to claim 11, wherein the image selection section selects an image to be delivered to the other image display device based on a result of an operation or processing performed on the image, and records identification information of the selected image in a predetermined storage area; and
the delivery section delivers to the other image display device an image corresponding to the identification information recorded in the predetermined storage area by the image selection section.

15. The image delivery system according to claim 14, wherein the delivery section moves the identification information of the image that has been delivered to the other image display device to a delivered image storage area and records the identification information in the delivered image storage area.

16. The image delivery system according to claim 11, wherein the result of an operation or processing performed on the image is any one of a viewing duration of the image, the number of views of the image, a result of facial recognition performed on the image, an editing history of the image, the number of copies of the image, the number of prints of the image, information regarding whether or not of the image has been transferred to the other device, and a facial expression of a viewer viewing the image which is determined by facial recognition; and
the image selection section selects an image to be delivered to the other image display device based on anyone of the viewing duration of the image, the number of views of the image, the result of facial recognition performed on the image, the editing history of the image, the number of copies of the image, the number of prints of the image, the information regarding whether or not of the image has been transferred to the other device, and the facial expression of the viewer viewing the image which is determined by facial recognition.

17. An image delivery server that is connected to a first image display device and a second image display device via a network, comprising:
a first storage area which stores a plurality of images received from the first image display device;
an extraction section which extracts an image that satisfies a predetermined condition from among the images stored in the first storage area;
a first transfer control section which transfers the image extracted by the extraction section to a second storage area in the server;
a second transfer control section which delivers the image transferred to the second storage area to the second image display device at a predetermined timing, and transfers the image to a third storage area in the server.

18. The image delivery sever according to claim 17, wherein the predetermined condition is any one of a viewing duration of an image in the first image display device, the number of views of the image, a result of facial recognition performed on the image, an editing history of the image, the number of copies of the image, the number of prints of the image, information regarding whether or not of the image has been transferred to an other device, and a facial expression of a viewer viewing the image which is determined by facial recognition.
